(19) United States
(12) Patent Application Publication
(10) Pub. No.: US 2012/0266841 A1
(43) Pub. Date: Oct. 25, 2012

(54) RICE, RICG, & RC

(76) Inventor: Seyd Mehdi Sobhani, Escondido, CA (US)

(21) Appl. No.: 12/931,870

(22) Filed: Apr. 25, 2011

(51) Int. Cl. F02B 53/00; F04B 35/04

(52) U.S. Cl. 123/245; 417/410.3

(57) ABSTRACT

FIG. 2 suggests an engine idea in which two interlocked rotors stop and turn in alternate fashion. If this suggestion is restructured as follows it would lead into the useful embodiments of this patent and more:

The blades of a Front rotor are interlocked with the blades of a Back rotor. With the help of a Front motor and a Back motor, a computer is able to drive said Front rotor and said Back rotor. The computer controls the sealed chambers between the blades of the Front rotor and the blades of the Back rotor to bring about the strokes similar to the strokes of the conventional internal combustion engines. Said structure therefore yields to the formation of three embodiments: a Rotary Internal Combustion Engine (RICE), a Rotary Internal Combustion Generator, and a Rotary Compressor/Liquid Pump (RC/LP).

### FEDERALLY SPONSORED RESEARCH

Not Applicable

### BACKGROUND FIELD

This application pertains to a Rotary Internal Combustion Engine (RICE), a Rotary Internal Combustion Generator (RICG), and a Rotary Compressor/Liquid Pump (RC/LP).

### BACKGROUND PRIOR ART

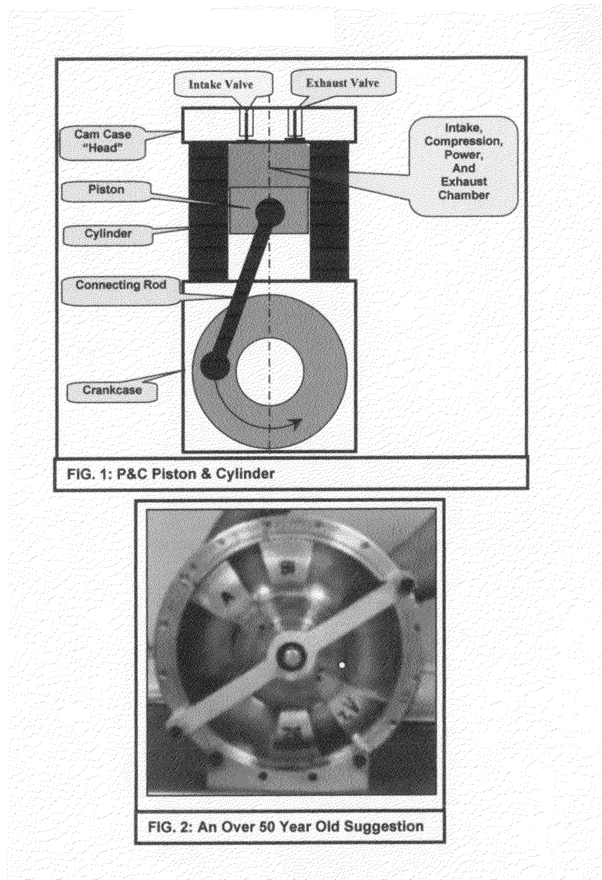

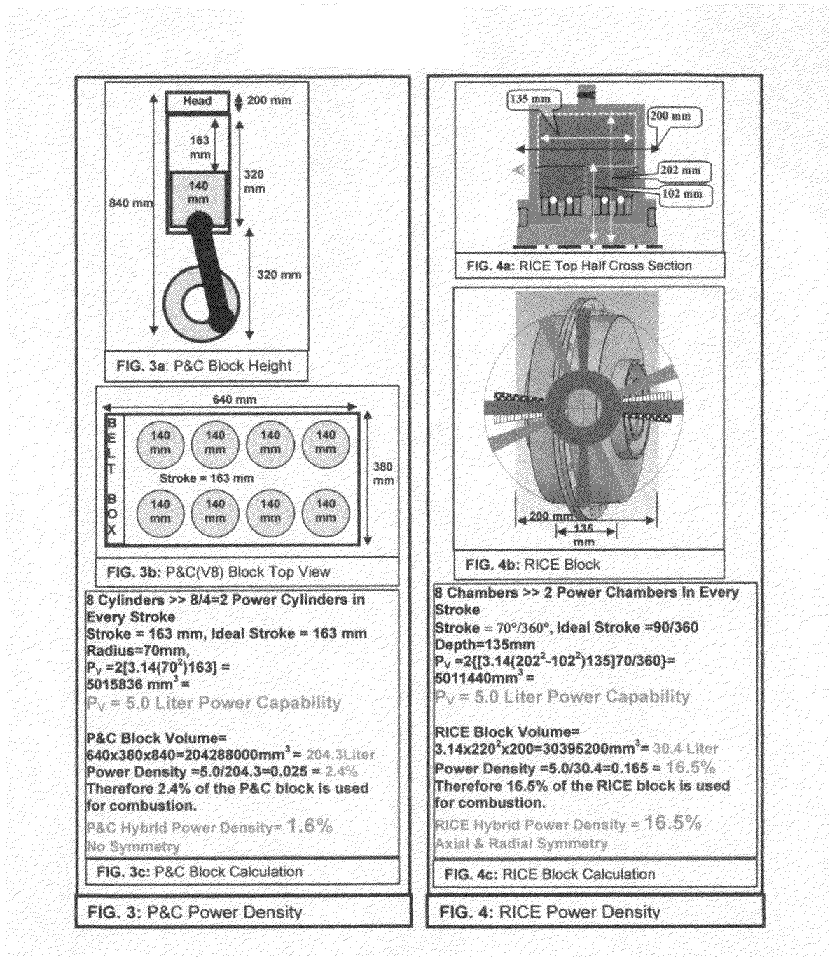

The confined space between the conventional piston and the cylinder (P&C), in FIG. 1, is the chamber that is used to process internal combustion. The hardware (the crank, the connecting rod, the cam shafts, the timing belt box, & the cylinder) that converts the linear motion of the piston into the rotary seems unnecessary. And through ages engineers have tried to invent a direct rotary combusting system in hope of eliminating said excess hardware and their associated losses. One attempt in this seemingly impossible challenge (Wankel—queasy-rotary, the crank is not eliminated) has even made its way to production. And yet today the P&C system dominates the world of engines, generators, and compressors by over 99 percent. The so called MYT engine (Massive Yet Tiny engine with U.S. Pat. No. 6,739,307) adds a set of connecting rods, sun & planet gears to the old suggestion of FIG. 2 to create an internal combustion engine. But this attempt ignores lubrication and balancing of said system. A straight forward, apple to apple, calculation (like the one shown in FIG. 3 & FIG. 4) on a well balanced (?) producible said MYT will prove that if power density of said MYT engine is not any worse than the conventional P&C, it is not any better. Categorically, all the previous internal combustion systems, (including MYT and Wankel), use hardware, (cranks, connecting rods, cam shafts, timing belt box, and or sun and planet gear system) to bring about the required strokes and rotation. Consequently an apple to apple calculation, proves that they all suffer from low power density and the inefficiency that these excess hardware cause. But the embodiments proposed in this patent breaks through that trend and discards the excess hardware by using computer software to bring about the strokes that an internal combustion system requires.

### SUMMARY

It is the intention of this patent to advance the rudimentary suggestion of FIG. 2 into three related embodiments: a true Rotary Internal Combustion Engine (RICE), a true Rotary Internal Combustion Generator (RICG) and a Rotary Compressor/Liquid Pump (RC/LP). The hope is to develop a structure that would be able to convert the different strokes of these mentioned systems into state machines that their steady state operations would consist of repeatable recipes that would yield to computer programming and computer manipulations. Achieving this goal will allow the replacement of the excess hardware (the cranks, the connecting rods, the cam shafts, the timing belt box; and or sun & planet gear system) with computer software; thereby increasing power density and efficiency.

### DETAILED DESCRIPTION OF THE ILLUSTRATED EMBODIMENTS

### Improvements:

Power Density Improvement: It is conventionally popular to use the displaced volume of an engine as a measure of its power capability. For example, it is well understood that a 5 liter engine is more powerful than a 4.7 liter engine. The tabulated dimensions in FIG. 3a and FIG. 3b are based on a conventional 5 liters, V8 piston & cylinder (P&C) engine. The tabulated dimensions in FIG. 4a and FIG. 4b are based on an equivalent 5 liter, 8 chambers RICE that is introduced in this patent. Engineers in the art could easily scrutinize the numbers and find that they are reasonable. The power capability equation that this patent uses is: Power Volume=Pᵥ=(the number of power strokes present in every stroke) multiplied by (the displaced volume of a chamber). An 8 cylinder 4 strokes P&C has 2=8/4 power strokes present in every stroke. FIG. 6b shows that the 8 chamber 4 strokes RICE has also 2 power strokes present in every stroke. As are shown in FIG. 3c & FIG. 4c the calculated power capabilities of the P&C & the RICE are 5.0 liters. But the engine block volume of RICE is 33.4 liters, while the engine block volume of the P&C is 204.3 liters. The power density equation that this patent uses is: Power Density=100(Power Volume)/(Block Volume). The power density of RICE therefore is calculated to be 16.5%, while the power density of the P&C is calculated to be 2.5%. Since RICE is inherently hybrid we have to convert the considered P&C into a hybrid engine as well. A conservative estimate for the power density of an equivalent hybrid P&C would be: 2.5%-0.9%=1.6%. In other words, 1.6% of the hybrids P&C block is used for power production, while 16.5% of the hybrid RICE block is used for power production. We shall see that for higher power RICE topologies with rotors of 6 & 8 blades, the power density will improve to over 30%. This outcome should not be too surprising—after all the invention is pursuing a rotary engine in hope of eliminating the camshafts, the timing belt box, the crankcase, the connecting rod, and the linear motion of the piston. This advancement cannot be ignored; because the engineers in these arts can conjecture that an improvement of this magnitude in power density would also bring with it other improvements that cannot be well quantized until later maturations.

### Efficiency Improvement:

1. Less Parts; Less Friction: The frictional losses associated with the eliminated parts (the cranks, the connecting rods, the cam shafts & the timing belt system, and or the sun & planet gears system) are saved.
2. Lighter Engine; Less Mass to Move: Better power density translates to smaller engine weight. Average engine cars weights are about 8 percent of the grouse weight of these vehicles. This means the conventional cars use 8 percent of their fuel to transport the weight of their P&C engines. We already proved that the engine of a car would be better than ten times smaller if it would be RICE instead of a P&C. This means if a car was to use RICE instead of its conventional P&C, it would spend only 0.8 percent of its fuel for the transportation of its RICE engine, (assuming the mass density of RICE would be more or less equal to the mass density of P&C engines). Therefore the efficiency of an average car will improve by 7.2% just because the power density of RICE is so much better than an equivalent P&C. For aircrafts that use P&C the percentage weight of the engine is higher than the assumed 8 percent of the grouse weight. Therefore the efficiency improvement would be better.
3. Optimum Operation: In a P&C all the four strokes take place in the same chamber but at different times. In RICE all the four strokes take place simultaneously but in different chambers (FIG. 6a). There are many P&C engines with a single cylinder/chamber. But a single chamber RICE does not exist. Therefore fundamentally a P&C system distributes its strokes over time, but RICE distributes its strokes over space. This fundamental difference dictates the P&C to possess an elaborate active valve system that have to open and close at precise optimum moments in each cycle. As the operating point (RPM, output power, temperature, etc.) of the P&C changes the optimum timing of the valves also have to change. But mechanically coupled cam-valves are not easily adaptive. And if the valves open and close inaccurately, the system would operate sub optimally and less efficiently. In RICE the rotors are mechanically free—there is no camshaft or sun and planet gear system to mechanically lock them together. The rotors are controlled by adaptive software that would keep the system optimum (most efficient) at all points of operation. Even compression ratio would be controlled for better operational efficiency.
4. Better Hybrid Operation: Associated with the motoring mode of a hybrid P&C are unwanted losses of compression and expansion of the gasses in each cylinder. But during motoring mode, the two rotors of RICE stay fixed relative to each other (the servo issues FCCBCC during pure electric mode). Therefore intakes, exhausts, and compressions do not take place in RICE during pure motoring, which leads to an overall better efficiency.
5. Idle Energy: Three of the four strokes of the conventional engines are energized by the kinetic energy stored in the flywheel. The flywheel has to speed up from zero to idle rpm (about 1000 rpm) before being able to supply the three of the four strokes of each cycle. It takes more energy and more time to start the conventional engines because it requires converting the electric energy stored in the battery into the kinetic energy of the flywheel that supplies three of the four strokes of a cycle. Therefore when a car is stationary at stoplights, it is more convenient to let it idle than restarting it when the light turns green. But in RICE there is no conversion because the three of the four strokes are directly energized by the battery at all times. Starting RICE is the same as its steady state operation. Therefore when a car stops the computer controlled RICE also stops combustion.

Higher than P&C RPM Operation: Output power is directly proportional to the operating frequency for both systems (P&C and RICE). If the valve springs in a P&C system are too weak, the valves will bounce of the cams as soon as RPM goes up. At high RPM the valves open and close improperly, which causes the efficiency to dramatically drop. And if the springs are too strong friction and wear go up. To reduce the wear, the tail valves have to become larger which will then require stronger springs. This phenomenon limits the P&C system from high RPM operation (when RPM>5000). The high frequency operation of RICE is not limited by valves, because it does not have valves.

New Inventions Incentive: There are already several unmanned experimental aircrafts (Quadra Copter, dragonfly, etc) that can only work with electric motors. This is because the power density of an electric motor is higher than a comparable medium and small size engine (P&C or Turbine). Higher power density, computer control, and versatile form factor allows RICE to resolve the limitations of today's engines. RICE is really two electric motors fortified with combustion. RICE will be able to power large, medium, and even small robots. It would also allow the imaginations of tomorrow's inventors give birth to new inventions that would be otherwise not possible.

### Introduction

For consistency, briefness, and clarity only the four stroke systems are considered here. Also, all the designs in this patent rotate counterclockwise. In FIGS. 5, 6, and 7 the topological basics of RICE are introduced.

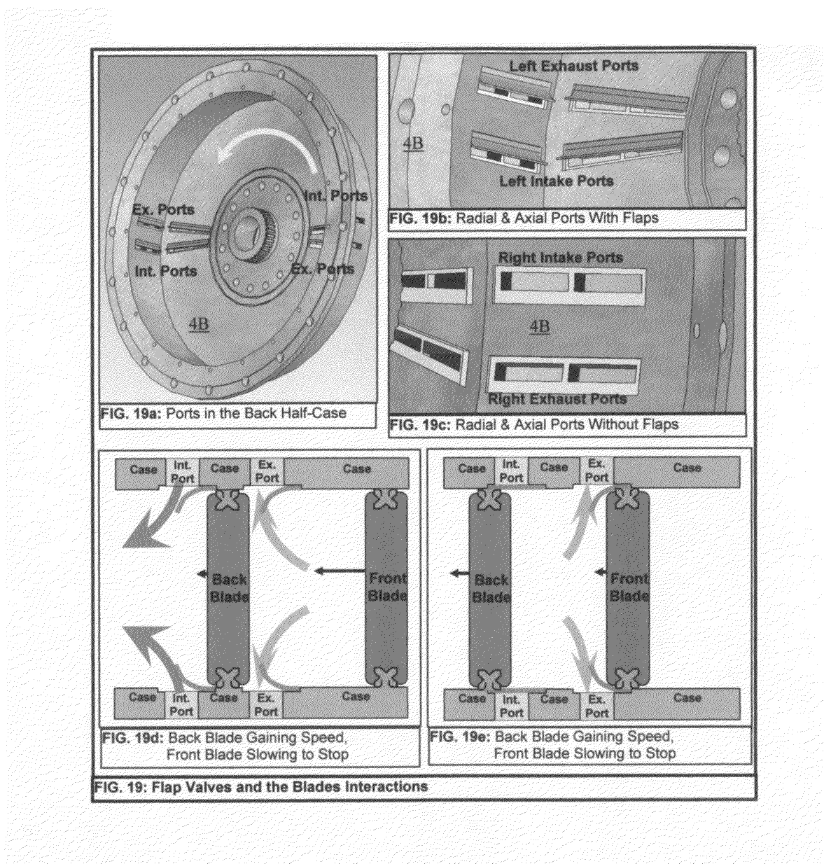

Rotor Blade: Item “3” in FIG. 5 is a rotor blade. The two lower corners of the base of a blade are made with less than 90 degree angel (85 degrees). This would allow the rotor hub (item 2 in FIG. 5) to mechanically bond to its blades. The blades' base dimensions are microscopically larger than the hub grooves that house the blades' bases. Much like tightening a nut on a bolt, the blades are press fitted into the hub grooves. FIG. 5a depicts that the edges of a blade that would come in contact with the inside of engine case or the hub of its coupled rotor are equipped with rectangular grooves to house the blade seals. For closer to ideal operation, a rotor blade has to be made as thin & light as possible. One of the factors that limit the thickness of a blade is the width (x direction dimension in FIG. 17a) of the blade seals. As shown in FIG. 5a, a small sensing target (magnetic material) is inserted and bonded at the base of each blade. During engine operation, six sensors that are mounted on the engine case (three on the Front half and three on the Back half of the engine case) sense a blade as it passes by them. As shown in FIG. 5b, a tiny hole at the base of a blade allows oil, from the core of the engine to enter the blade's sealing system—more on this later.

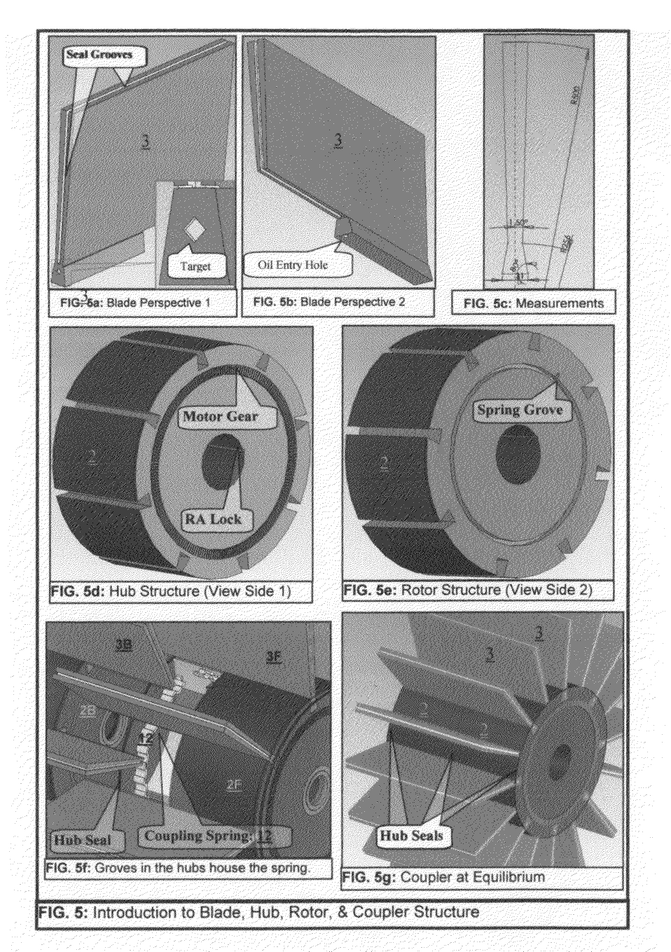

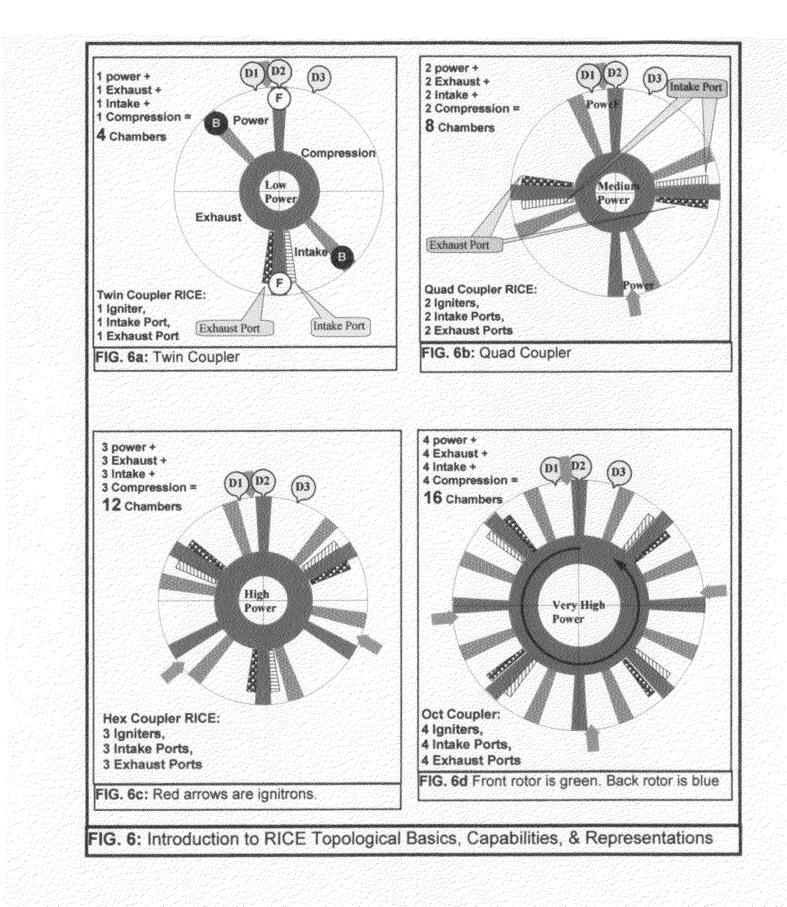

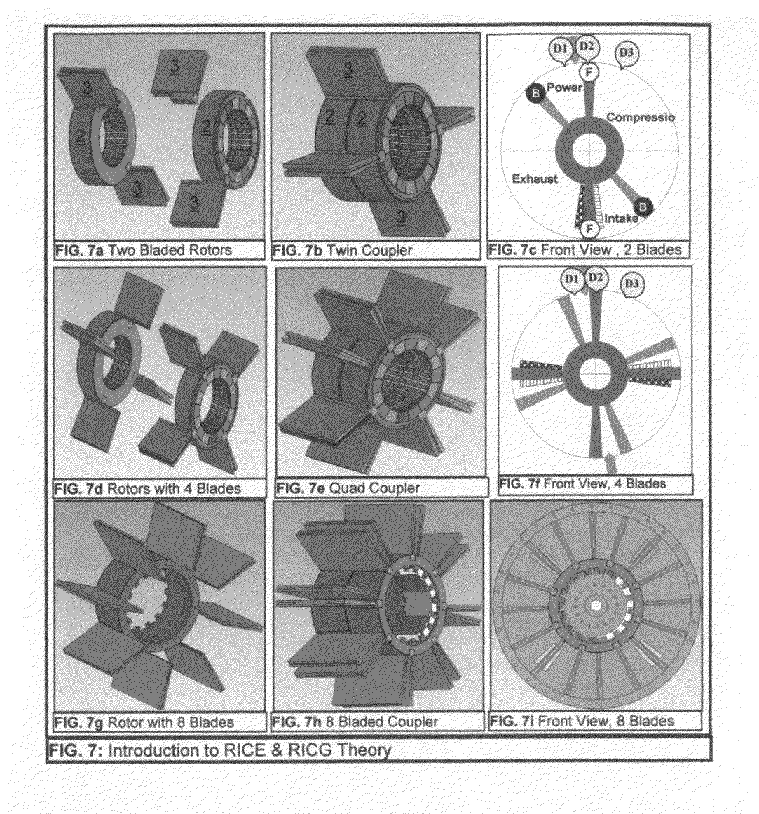

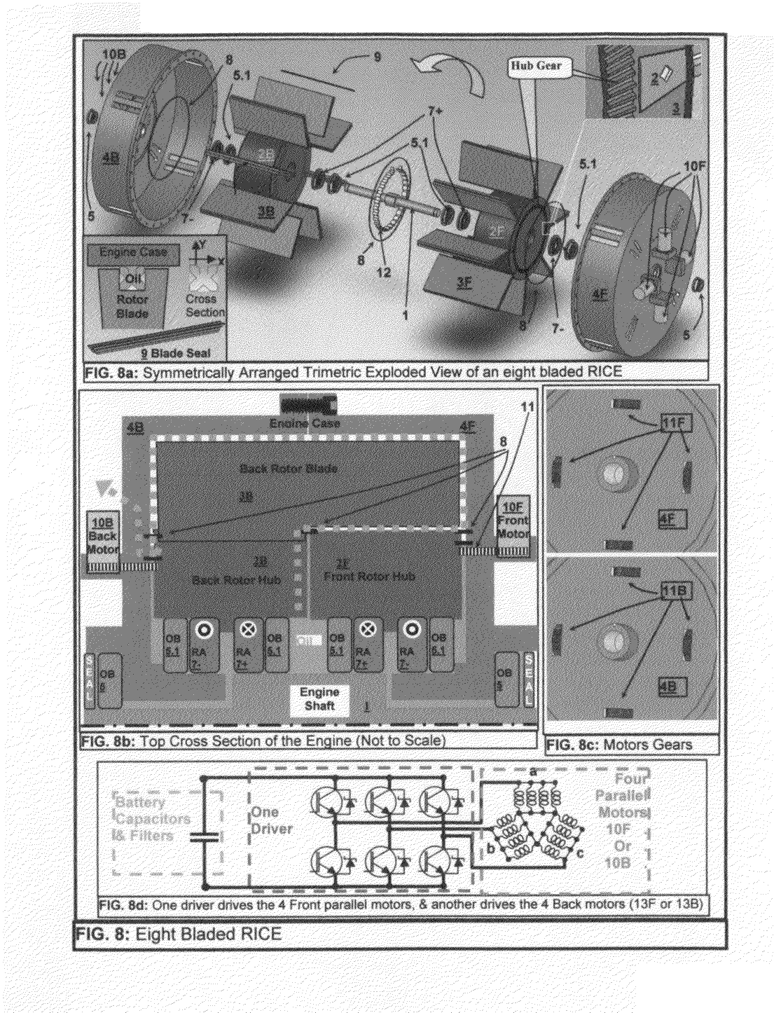

Rotor Hub: Item “2” in FIG. 5d is the hub of an 8 bladed rotor. The grooves on the cylindrical side of the hub house the bases of the 8 blades. The angels of the two corners of the grooves are the same as the bases of the blades (85 degrees). The gear teeth on the face of the hub shown in FIG. 5d are designed to mechanically engage with four small motors through four tiny gears (FIG. 8a, & FIG. 8c item 11 is the gear, & item 10 is the motor). The circular groove on the other face of the hub, shown in FIG. 5e, is designed to house half of a corrugate coupling spring (item 12 in FIG. 5f & FIG. 28). Each end of the spring is locked to one of the two hubs. The groove inside the central hole of the hub, shown in FIG. 5d, is designed to lock two ratchet assemblies (RA). Beside the two RAs, the central hole also houses two oil bearings.

Rotor: A rotor is formed when an even number of blades (2, or 4, or 6 . . . ) are symmetrically and evenly attached to a hub as shown in FIG. 5f, FIG. 5g, FIG. 7a, FIG. 7d& FIG. 7g.

Coupling Spring: FIG. 28 depicts how a strip of spring steel could be formed into a corrugated loop. FIG. 28e & FIG. 28f show that the circular grooves on the adjacent faces of the two hubs house the coupling spring.

Coupler: A coupler is formed when two identical rotors are interlocked as shown in FIG. 5f, FIG. 5g, FIG. 7b, FIG. 7e, FIG. 7h, & FIG. 28d. The coupling component is the corrugated spring introduced in the previous paragraph. FIG. 28e & FIG. 28f show how the two ends of the coupling spring are attached to the inside grooves of the two hubs of the two interlocked rotors. FIG. 28d shows that the spring forces the relative positioning of the two rotors such that the blades of one rotor would be equidistance from the blades of the other. The hub grooves that house the spring are large enough to allow the necessary relative normal movements of the rotors of a coupler. But the circular grooves are small enough to stop the abnormal movements when the blades of one rotor wants to collide with the blades of the other: Under normal operation the coupling spring bends as a blade swings right and left between its two adjacent neighbors. But when a blade approaches too close to its right neighbor, the outer cylindrical walls of the spring grooves stop the spring from bending. From here on if the blade wants to approach its right neighbor further, the spring has to compress instead of bending. Compressing the spring requires much larger force than bending it. By the same token if a blade approaches too close to its left neighbor, the inner cylindrical walls of the spring grooves stop the spring from bending. From here on if the blade wants to approach its left neighbor further, the spring has to stretch instead of bending. Stretching the spring requires much larger force than bending it. The right rotor in the figures is called the “Front Rotor”, and the left rotor is called the “Back Rotor” of the coupler.

Front Half-Case: Item 4F in FIG. 8a is the Front-half of the engine case.

Back Half-Case: Item 4B in FIG. 8a is the Back-half of the engine case which is the mirror image of the Front-half-case.

Engine Case: The two almost identical Front & Bach half cylindrical cavities (4F & 4B) join to encapsulate a coupler (FIG. 7i).

Top: Top of the engine is defined by the positioning of the ports in each half-case: A vertical line that passes through the center of the case defines the top of the engine if the ports are symmetrically arranged with respect to this line.

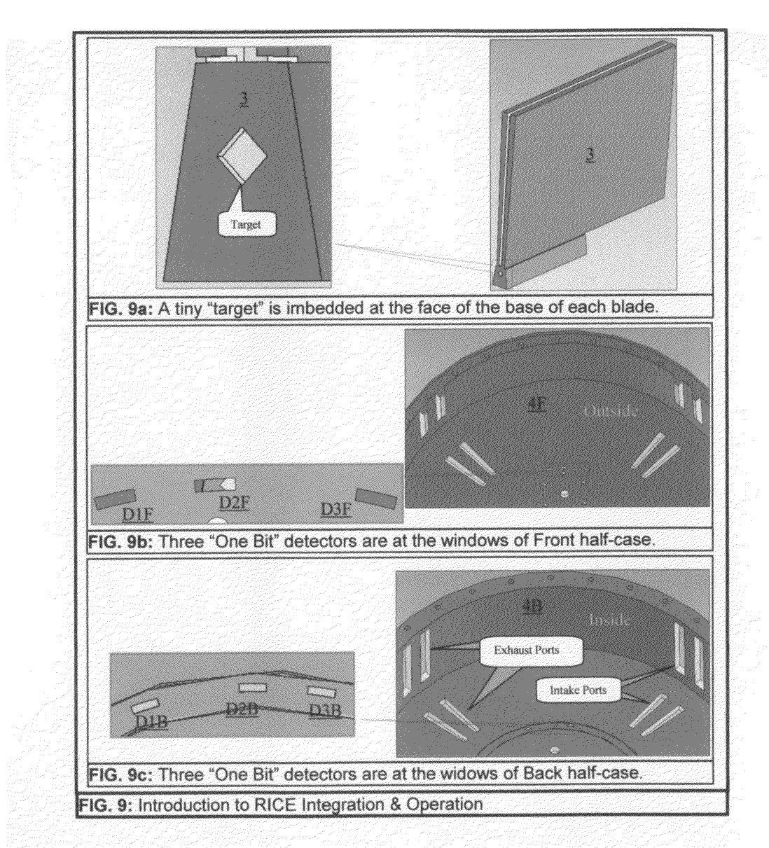

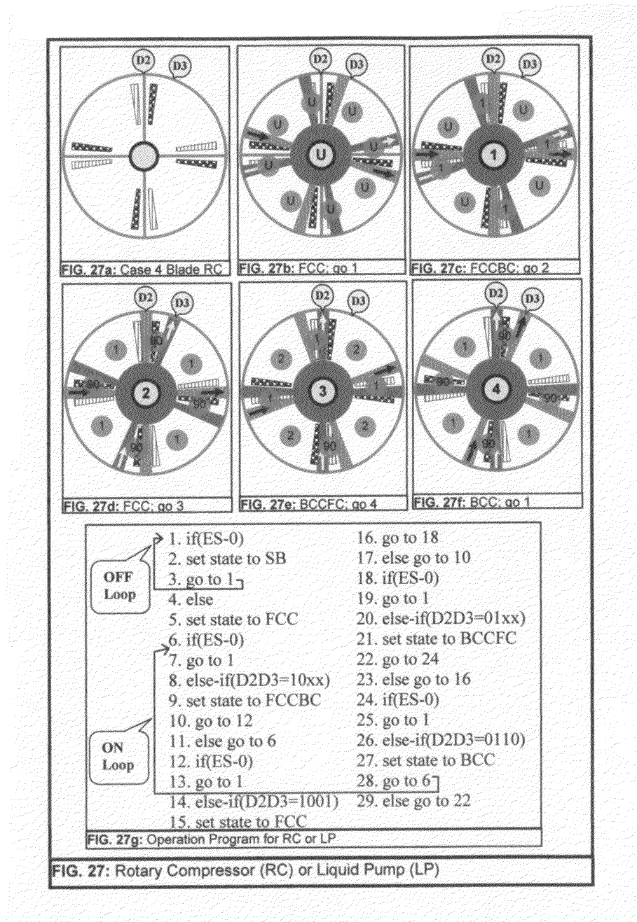

Ports: Blades and ports have to be as narrow as possible to allow the maximum stroke. FIG. 8a, FIG. 9b, & FIG. 9c indicate that ports are radial and axial narrow pie-slice-cuts into each half-case. FIG. 6 indicates that for RICE & RICG when one of the blades of a rotor (Front in FIG. 6) is directed toward the top, then exhaust and intake ports are positioned at both sides of alternate blades of that rotor (Front in FIG. 6). But for RC/LP when one of the blades of a rotor (FIG. 25a) is directed to the top, then exhaust and intake ports are positioned at both sides of every blades of that rotor (FIG. 25a). In other words there are twice as many pairs of ports (pair=intake port+exhaust port) in RC/LP than there are in RICE & RICG.

Radial Ports: As shown in FIG. 6, FIG. 9b & FIG. 9c narrow pie slices are symmetrically cut into the face of each half-case. The shape and the dimensions of these ports are driven by the shape and the dimensions of the topology & the blades.

Axial Ports: As shown in FIG. 9b & FIG. 9c rectangular holes are cut inside the cylindrical sides of each half-case. Axial ports are along the radial ports. The shape and the dimensions of these ports are driven by the shape and the dimensions of the topology & the blades.

FIG. 6a represents the front view of an engine that is built from rotors with 2 blades (Twin Coupler RICE). The Front Rotor is green and the Back Rotor is blue. This engine is suited for low power applications: Chain Saws, Lawn Movers, Weed Walkers, Model Airplanes, etc. Because this engine has only one power chamber, the torque that this single chamber applies to the system is not symmetrical.

FIG. 6b represents the front view of a quad coupler RICE (an engine that is built from rotors with 4 blades). The Front Rotor is green and the Back Rotor is blue. This engine is suited for medium power applications: Cars, Boats, A Few Passenger Airplanes, etc. Because this engine has two power chambers that simultaneously apply symmetrical torque to the system, the engine vibration would be low.

FIG. 6c represents the front view of hex coupler RICE (an engine that is built from rotors with 6 blades). The Front Rotor is green and the Back Rotor is blue. This engine is suited for high power applications: Trucks, Tanks, Combines, Helicopters, Several Passenger Airplanes, etc. Because this engine has three power chambers that simultaneously apply symmetrical torque to the system, the engine vibration would be low.

FIG. 6d represents the front view of an engine that is built from rotors with 8 blades. The Front Rotor is green and the Back Rotor is blue. This engine is suited for very high power applications: Ships, Many Passenger Airplanes, Locomotives, Submarines, Earthmovers, Tugboats, etc. Because this engine has four power chambers that simultaneously apply symmetrical torque to the system, the engine vibration would be low.

Physical Structure: FIG. 8a depicts a symmetrically arranged trimetric exploded view of an eight bladed RICE. The radial and axial symmetry of this engine is noteworthy. FIG. 8b is a representation of the top half sectional view of the engine, which is not to scale. The orange color (oil) in this figure indicates that the shaft, all the OBs, and all the RAs are submerged in oil. The dashed orange line in FIG. 8b indicates that there are passages through the hubs that allow oil from the core of the engine to enter the blade seals (item 9 in FIG. 8a). The close up picture shown in the left lower corner of FIG. 8a also indicates that oil flows inside the 4 seals that frame a blade. The oil lubricates and cools the sliding surfaces that the blade seals come in contact. Two rather identical half-cases (reference # 4F & 4B) are attached together by several bolts, one of which is shown at the top of FIG. 8b. The purpose of the case is to house and support the engine components and the engine operation. Reference 1 in FIG. 8 is the engine shaft which is supported at its two ends by two identical oil bearings with reference number 5. The two inner centers of the two half-cases, house the two identical oil bearings with reference number 5.1. These two oil bearings support the two nonadjacent ends of the two hubs (reference # 2F & 2B). The two adjacent ends of the two hubs ride on two other identical oil bearings with the same reference number 5.1 which are supported on the middle section of the engine shaft. The two inner centers of the two half-case also house the two identical RAs (ratchet assemblies, reference # 7−) each of which couples one of the half cases to the hub of one of the rotors. The minus sign (7−) signifies that the directions of the RAs that couple each of the two rotors to each of the half-cases, are such that each rotor is able to rotate counterclockwise with respect to its half-case. Because of the directions of these two RAs, the rotors will then of course not be able to rotate in the clockwise direction with respect to the case. The middle section of the engine shaft house two ratchet assemblies with reference number 7+ each of which couples the shaft to one of the two rotors. The plus sign (7+) signifies that the directions of the couplings are such that the shaft is able to rotate counterclockwise with respect to the coupled rotor. Because of the directions of these two RAs (7+), the shaft will then of course not be able to rotate in the clockwise direction with respect to the coupled rotors. The four small Front motors with reference number 10 are geared to the Front hub through four tiny gears with reference number 11; the close up of which are shown in FIG. 8c. The three phases of the stators of each of these four motors are wired in parallel as shown in FIG. 8d. As shown in FIG. 8d, a single motor driver is capable of simultaneously driving the four motors. The four Back motors with the same reference number 10 are geared to the hub of the Back rotor through four other tiny gears with the same reference number 11. The stator phases of the back four motors are also wired in parallel, and a single driver similar to the one shown in FIG. 8d would be able to simultaneously drive the four Back motors.

Structural & Operational Constraints: The engine and the motors form an electro combustion structure with the following constraints:

a. The two RAs (reference # 7−) would only allow each of the two rotors rotate counterclockwise relative to the case.
b. The two other RAs, (reference # 7+) would only allow the shaft to rotate counterclockwise relative to each of the two rotors and therefore relative to the case.
c. The shaft is free to rotate counterclockwise while one or both rotors are kept stationary by force.
d. If a rotor is rotating (counterclockwise of course) then the shaft has to rotate with the rotor or faster than it.
e. If both rotors are rotating then the shaft has to rotate as fast as the faster rotor or faster.
f. The eight motors can drive the shaft counterclockwise together or independently.
g. The Front four motors are able to force the Front engine rotor to stand still, by trying to turn the Front rotor clockwise.
h. The Back four motors are able to force the Back rotor to stand still, by trying to turn the Back rotor clockwise.
i. Redundancy: depending on the size of the selected motors; any one, two, or three of the Front or the Back motors could fail yet the engine would still function with the help of the remaining healthy motor.
j. When one set of the motors are doing C (Clockwise) the other set could share the load even during combustion.
k. Both sets of the motors could share the load during the periods that C is not required.
l. If combustion system is down, the load could still be driven by one or both sets of the motors.
m. If any sets of motors (Front 4, or Back 4) are down combustion is also down. But the other healthy set could still drive the load.
n. The coupling spring with reference number 12 is designed such that in case of a malfunction, the required force to make the blades of one of the rotors collide with the blades of the other is larger than the average forces the system can create.
o. The coupling spring guarantees the blades would never come closer to each other than the distance between the detectors (D1, D2, & D3).

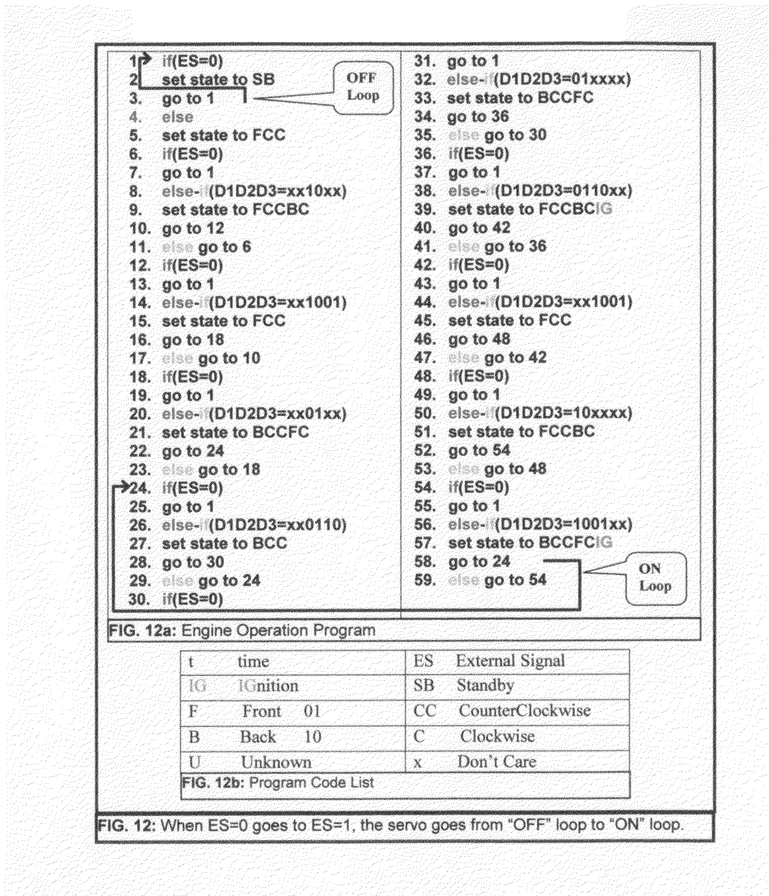

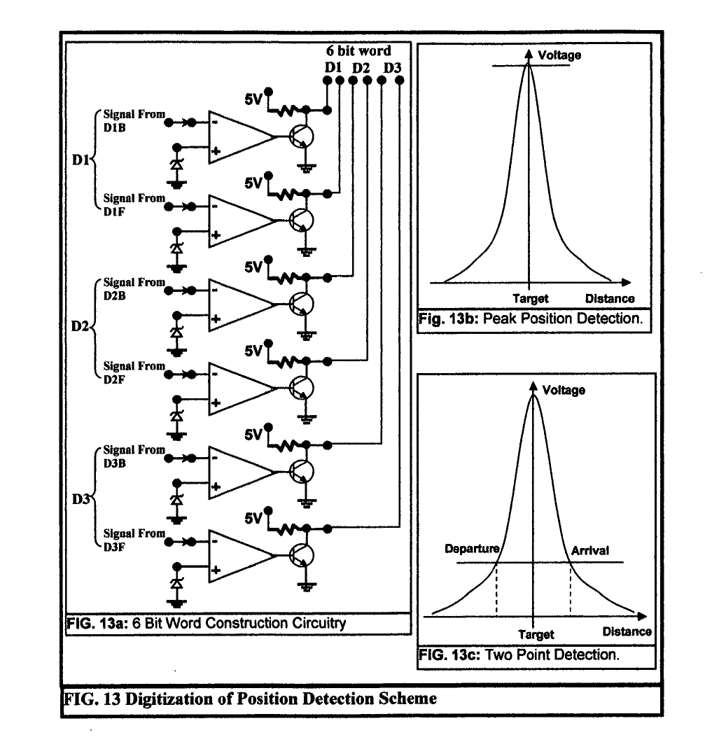

Targets & Detectors: Unimaginable amounts of trial and error have lead to what have been presented up to now. The evidences, however, indicate that the initial hope of converting this engine into a state machine might indeed materialize. But there are still several unimaginable amounts of work ahead. FIG. 9a indicates that a small target is imbedded at the face base of each blade. The target could be magnetic, capacitive, or optic. FIG. 9b & FIG. 9c show three tiny windows on each half of the engine case. These six windows allow six detectors to electronically detect these targets when they pass close to them. Associated with each window there is one detector and one wire (D1B, D1F; D2B, D2F; D3B, D3F). As shown in FIG. 13a, each wire is part of a circuit which would raise the voltage of an electrical node from a low state (0 volt) to a high state (5 volt) when a target comes close to its associated detector. The generated node is, therefore, either electrically high which the servo would interpret as “1”, or the node could be electrically low which the servo would interpret as “0”. As shown at the top right corner of FIG. 13a the six generated nodes are arranged to produce a six bit word with the following definition: “D1D2D3”=D1B, D1F; D2B, D2F; D3B, D3F. The program in FIG. 12a periodically directs the servo to read this word to help it decide how to progress the engine.

BLDC Detector: A Brush Less DC motor must be equipped with detectors to figure out the position of its rotor so that it would be able to commutate current into the appropriate phases of the stator. If BLDC were used to fulfill the function of item 10, then it would be possible to use the detectors of the BLDC instead of D1, D2, &D3 provided the coupling between the motors rotors and the engine rotors are taken into account. It is also possible to use encoder boxes that are coupled to the gear 11.

Logic of the Detectors: Detector D2 is required for geometrical referencing; it identifies the top of the engine. The ports of RICE were symmetrically arranged about a line that passes through the center and top of the engine. FIG. 6 indicates that when a blade of a RICE rotor is positioned in the top direction, then the alternate blades of that rotor would be positioned in between and next to the intake and exhaust ports. This would be one of the optimum criteria for RICE design. D3 is required for optimum intake and optimum exhaust: Subject to the a safe blade positioning capability of the system, D3 shall be placed as close to D2 as possible: when a rotor is stopped at D2 and the other rotor is forced to turn, by the time the turning rotor reaches D3, enough air has been taken into the intake chambers, and enough exhaust has been expelled from the exhaust chambers. D1 is required to identify the compression condition: under steady state the instant D1 and D2 simultaneously report blade detection, the pressure of the chamber between those two detected blades, (all the power chambers of the engine) would satisfy compression requirement, which prompts the servo to issue combustion. The derivation for the exact positioning of the detectors is beyond the scope of this patent. Their positions, however, could be tuned experimentally for efficiency, compression ratio setting, and pollution optimization.

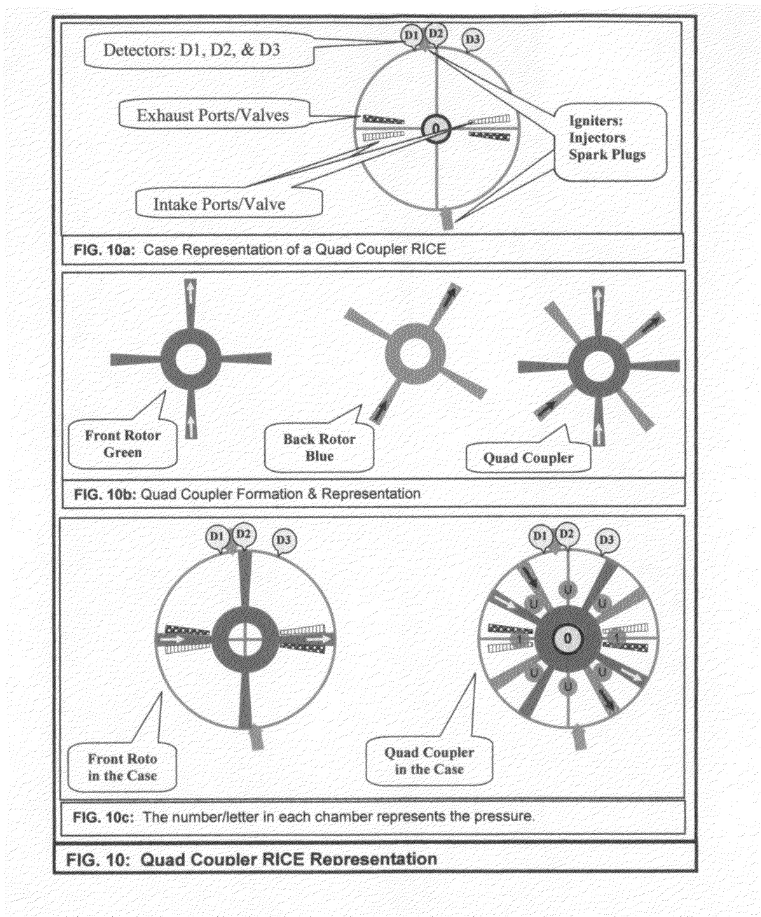

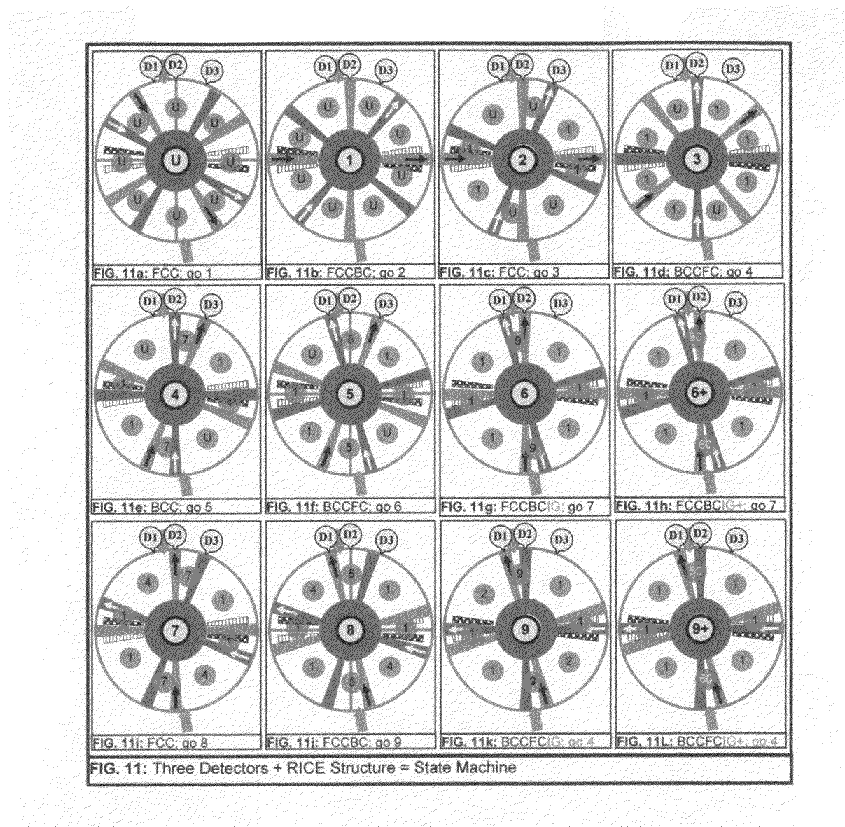

Representation: To avoid cluttering the representations of FIG. 11, a four bladed RICE shall be considered instead of the eight bladed one that has been developed up to now. FIG. 10a represents the engine case of a four bladed RICE. To avoid cluttering, the detectors D1, D2, & D3 are represented at the perimeter of the case rather than at their actual places which are inside the perimeters of the two hubs, as shown in FIG. 9b and FIG. 9c. The top of the engine is defined by a vertical line with respect to which the ports are symmetrical arranged at both of its sides. FIG. 10b depicts the representation of the Front and the Back rotor and also when these two rotors are coupled. The yellow and black arrows on two of the blades of each rotor are only to help the reader track the progression of the engine. The servo does not differentiate between the blades of the same rotor. FIG. 10c integrates the representations of the case and the quad coupler. The two red fat arrows at near the top and near the bottom shown in FIG. 10c represent the combustion system, (the fuel injectors and spark plugs). The left representation in FIG. 10c contains a small circle in each of its eight chambers. The letter u in these circles signifies that the pressures of those chambers are unknown. The pressures of the two chambers that have access to the intake ports are 1 atmosphere; therefore the circles in these chambers are marked with 1. The number at the center of the representation marks a snapshot of this dynamic system which is frozen in time. The right presentation in FIG. 10c indicates that when a blade of a rotor is vertically positioned under D2, its horizontal blades are exactly between and next to the intake and exhaust ports.

Intake & Exhaust Ports: In a quad coupler RICE, the theoretical ideal stroke angle would be: 360/4=90 degree (FIG. 6b). This theoretical value could only be achieved if the rotor blades and the ports had zero thickness. Therefore to stay close to the theoretical ideal value, the blades and the ports have to be designed as narrow as the other constraints allow. The right picture in FIG. 10c indicates that in a quad coupler RICE one pair of ports has to be placed at +90 degree, and the other pair at −90 degree relative to the top of the engine. This picture also indicates that the intake and exhaust ports have to be as close to each other as the thickness of the blades and the blade positioning capability of the system allow.

Equilibrium Seek: The trapped gasses in the chambers that do not have access to the ports do not allow the blades of one rotor to collide with the blades of the other. In other words it takes infinite force to compress the air in the compression chambers to the point that the blades would collide—provided the sealing system is perfect. This is a nice natural guarantee for the collision concern of the rotor blades. Yet a fail safe structure would be equipped with a design feature that would actively force the rotors of a coupler to position the blades at equal distance from each other. FIG. 28 depicts such a feature. FIG. 28a & FIG. 28b depict a corrugated circular spring made from a simple ribbon of spring steel. The radial extended ends of the spring are cut half width. This would let each end to lock into the hub groove of each of the two rotors as shown in FIG. 28e & FIG. 28f. For an 8 bladed rotor the ideal stroke angle is 360/8=45 degrees. The free angle between the radial ends of the spring is 22.5 degrees (FIG. 28a, the angle=22.5 degree). When the coupler is assembled, as shown in FIG. 28d; the spring will seek equilibrium and will force the two rotors to position themselves with their blades at equal distances from each other. Although the spring is made from a rather thick ribbon, when it is free it requires relatively a small force to bend it open, or bend it shut. But the bending range of the corrugated spring could be limited by the confinement of appropriately sized hub grooves. The grooves shall be dimensioned such that if the blades try to get closer to each other than the distances between the detectors, (D1, D2, & D3) then they have to either compress or stretch the spring instead of bending it. Compressing or stretching the spring requires much larger force than bending it.

Engine Program & Operation: To create a program that could run this engine, the states of this machine have to be defined and the cause and effect between the consecutive states have to be justified. The word “servo” is referred to the electronic that is capable of executing the engine program in conjunction with the internal and external signals. A one bit External Signal (ES) communicates the wish of the engine user to the servo of the system. D1, D2, & D3 together with the circuit in FIG. 13a communicate to the servo a six bit word internal signal. The statement “if(condition), else” consists of the “if(condition)” phrase, and the “else” phrase. If the condition of the “if(condition)” phrase is not satisfied, the servo will not execute the statement that follows it. Instead the servo jumps to the “else” phrase and executes the statement that follows the “else” phrase. But if the condition of the “if(condition)” phrase is satisfied, the servo executes the statement that follows the “if(condition)” phrase. The statement “else-if(condition), else” has the same logical relationship. When the system is powered up the servo will start executing the first statement of the program in FIG. 12a. During the time when ES=0 the servo hops around the short “OFF Loop” which goes from line 1 to line 3 and back to line 1 of the program in FIG. 12a. The snapshot U in FIG. 11 a depicts the engine at an Unknown condition where the pressures of the chambers, the amount of air in either one, and the positions of the rotors are unknown. The coupling spring guarantees that the distance between any two consecutive blades would be larger than the distance between the detectors. At this stage the servo senses that ES has been changed from (ES=0) to (ES=1). Therefore the servo jumps to “else” phrase in line 4 of FIG. 12a. The program therefore allows the servo to move to line 5 which directs it to change the state of the system from SB to FCC. According to the code definitions logged in FIG. 12b, the code SB means StandBy; and the code FCC means turn the Front rotor CounterClockwise. Because of the trapped gasses in each of the 8 chambers and also because of the coupling spring, the turning of the Front rotor will also cause the Back rotor to turn CounterClockwise. The turning of the two rotors will eventually lead to D2 detecting the Back rotor. The event of D2 detecting the Back rotor is equivalent to (D1D2D3=xx10xx). This event satisfies the else-if(D1D2D3=xx10xx) condition of line 8 in FIG. 12a. During the time that the state of the system is FCC and the Back rotor has not yet reached D2, the servo runs around the local loop from line 6 to line 11 until the engine progresses to where the Back rotor reaches D2 and the condition for the else-if(D1D2D3=xx10xx) phrase gets satisfied. The snapshot 1 in FIG. 11b depicts the moment when the event (D1D2D3=xx10xx) has taken place. Upon this happening the program allows the servo to move on to line 9 which directs it to set the state to FCCBC. According to the program code definition in FIG. 12b, the code BC means, turn the Back rotor Clockwise. The turning of the Back rotor Clockwise causes the Back rotor to lock against the RAs. The set state FCCBC has therefore caused the Front rotor to continue turning CounterClockwise, while locking the Back rotor under D2. The snapshot 2 in FIG. 11c is when the Front rotor has reached D3 and the event (D1D2D3=xx1001) has taken place. At this time the chambers between the blades marked with yellow and black arrows have taken in as much air as possible, and their pressures are 1 atmosphere. In other words the intake strokes for the two chambers between the arrows are complete. This event has satisfied the else-if(D1D2D3=xx1001) condition in line 14 of the program in FIG. 12a. Therefore the servo is now allowed to execute line 15 of the program which directs the servo to let go of the Back rotor by removing BC from the state; while continuing turning the Front rotor by keeping the FCC portion of the state. Both rotors continue turning until the system progresses to snapshot 3 shown in FIG. 11d. Now D2 has detected the Front rotor which is the satisfying condition for the else-if(D1D2D3=xx01xx) phrase in line 20 of the program. This event allows the servo to move to line 21 which is directing it to set the state to BCCFC. BCCFC locks the Front rotor under D2, while forcing the Back rotor to turn CounterClockwise. The system is now forced to eventually progress to the snapshot 4 shown in FIG. 11e; where D2 has been indicating the Front rotor, and D3 has just detected the Back rotor. At this time the chambers between the yellow and black arrows have enough air with the pressure of about 7 atmospheres, and the two chambers that follow them have taken in as much air as possible with about 1 atmosphere pressure. This event is the satisfying condition for the else-if(D1D2D3=xx0110) phrase in line 26 of the program. Line 27 directs the servo to let go of the Front rotor while keep applying BCC to the Back rotor. Snapshot 5 shown in FIG. 11f is the next event (D1D2D3=01xxxx) at which the servo has to change the state of this dynamic system. The servo runs around a local loop, from line 30 to line 35 until the system progresses to where the event (D1D2D3=01xxxx) takes place. This event is the satisfying condition for the else-if(D1D2D3=01xxxx) phrase in line 32 of the program and allows the servo to move on to line 33 of the program. Line 33 directs the servo to set state to BCCFC, which locks the Front rotor under D1 while forcing the Back rotor to continue turning CounterClockwise. Snapshot 6 in FIG. 11g depicts the moment when D1 has been detecting the Front rotor and D2 has just detected the Back rotor (D1D2D3=0110xx). At this time the compression stroke for the two chambers between the yellow and black arrows are complete. This event is the satisfying condition for the else-if(D1D2D3=0110xx) phrase in line 38 of the program and allows the servo to move on to line 39. Line 39 directs the servo to set state to FCCBCIG. According to the program code list in FIG. 12b, IG means IGnition. This is the first power stroke of the engine being turned on from a cold start. Snapshot 6+ in FIG. 11h depicts a moment after IGnition; the configurations of the two rotors have not changed much, but combustion gasses have raised the pressure of the chambers between the yellow and black arrows from 9 atmospheres to about 60 atmospheres. Combustion pressure together with FCCBC are now pushing the Front rotor in the CounterClockwise direction; and locking the Back rotor under D2. Snapshot 7 in FIG. 11i depicts the moment when the Back rotor has been kept under D2, and the Front rotor has just reached D3. In other word the condition for the else-if(D1D2D3=xx1001) phrase of line 44 of the program has just been satisfied. At this time the program allows the servo to move on to line 45. Line 45 directs the servo to set the state to FCC. This would release the Back rotor and force the Front rotor to continue turning CounterClockwis. Snapshot 8 in FIG. 11g depicts the moment when the D1 has just detected the Back rotor. This would satisfy the condition of the else-if(D1D2D3=10xxxx) phrase in line 50 of the program. Upon this event the program allows the servo to move on to line 51 which directs it to change the state from FCC to FCCBC. BC locks the Back rotor under D1, and FCC forces the Front rotor continue turning CounterClockwise. Snapshot 9 in FIG. 11k is when D1 is still reporting the detection of the Back rotor, and D2 has just detected the Front rotor. The compression stroke for the two chambers following the ones with black and yellow arrows is complete. This would satisfy the condition of the else-if(D1D2D3=1001xx) phrase in line 56 of the program. Upon this event the program allows the servo to move on to line 57 in which the servo is directed to change state from FCCBC to BCCFCIG. Snapshot 9+ in FIG. 11L depicts a moment after IGnition: the configurations of the two rotors have not changed much; but combustion gasses have raised the pressure of the two power chambers from 9 atmospheres to about 60 atmospheres. The program repeats the engine cycle by running around the ON Loop from line 24 to line 58. During the engine operation if the user changes the state of ES from ES=1 to ES=0 the program automatically directs the servo to switch its operation from the “ON Loop” to the “OFF Loop”. The program in FIG. 12a is written such that engine would still serve the load even if combustion fail to take place. There are many other program possibilities for the operation of this engine.

Other Topologies: The same program is able to operate other RICE or RICG topologies with other than 4 blades rotors.

Refinement: This is an open loop control without any feedback. The switching of the system from one state to another could however be smoothened up by artificially limiting the rate of change of PWM (Pulse Width Modulation on motors) to a value that the system can afford.

For smoother and more efficient engine operation the detection of the target could be further refined. If in each small widow of FIG. 9b & FIG. 9c, two or three detectors were placed, then smoother and more efficient engine operation could be programmed. Each detector would report slightly different position of the blade. Tow position detecting could also be electronically extracted from the voltage profile that a target creates (FIG. 13c). The associated two position detection circuitry similar to FIG. 13a, which would create a nine bit word, has to be developed. They could then be arranged as follows: (000=No Blade), (001=Front Blade Arriving), (100=Front Blade Departing), (011=Back Blade Arriving), (110=Back Blade Departing). A lower current (smaller PWM) shall be programmed at arrival than at departure, which will lead into a more efficient operation. Higher digits binary numbers would lead to even smother and more efficient operations. An analog to digital converter produces a multitude of points signifying different proximity points of arrivals and departures. The associated engine program and detecting circuitry shall be provided upon request.

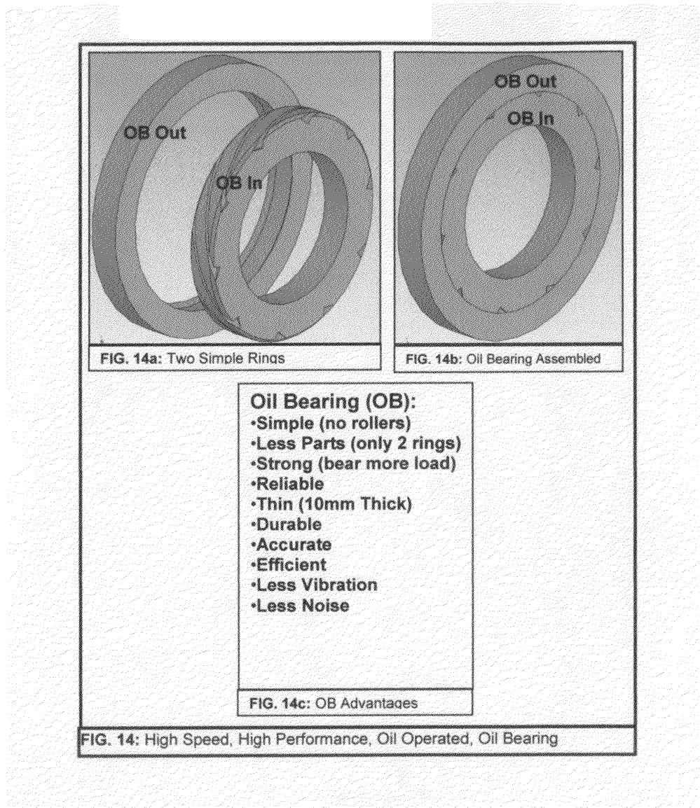

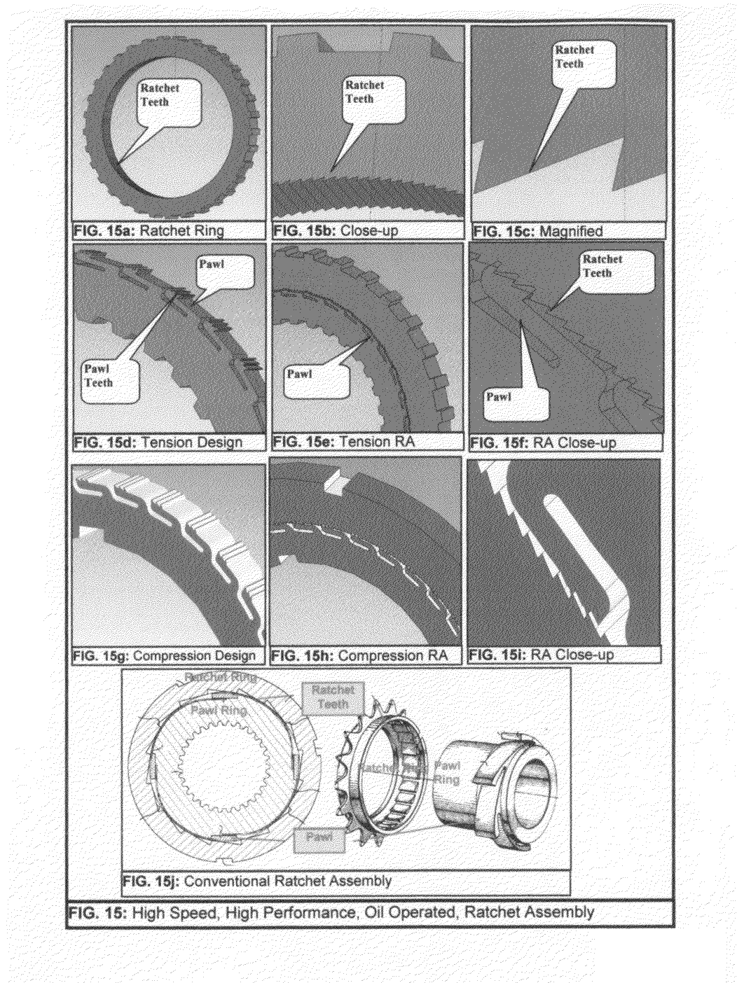

OB: Oil Bearing: An oil bearing is composed of a simple inner ring that nicely fits inside a simple outer ring FIG. 14. The ring that rotates relative to the bath of oil is obliquely grooved. The grooves help pump oil in between the sliding surfaces of the two rings. The inner surface of the inner ring is bonded to a shaft (press fit), and the outer surface of the outer ring is bonded to another component (hub or the engine case). Oil molecules role in between the two rings which eliminate sliding friction and allow these two rings function as a bearing with superior capabilities—some of which are listed in FIG. 14c. Because of the structural and operational symmetry, RICE does not require strong alignments from its bearings. Yet since the operating environment is saturated with oil, the design takes advantage and uses oil bearings.

### High Performance Ratchet Assembly (RA):

A ratchet assembly consists of a ratchet ring and pawl ring (FIG. 15j). A bearing element, which is not shown in FIG. 15j, is required to keep these two rings aligned with each other. Unidirectional bearing is an integration of the bearing element together with the two rings of the ratchet assembly. After integration, the spring loaded pawls couple the two rings of the ratchet assembly. The coupling is such that the two rings will rotate in one direction with ease, but will not rotate in the opposite direction relative to each other. Today many manufacturers use different proprietary techniques to produce ratchet assemblies, unidirectional bearings, and or mechanical diodes. The component that transforms any ordinary metallic ratchet assembly into a high performance ratchet assembly is oil. And since the bearings and the ratchet assemblies of the RICE system operate in a continually filtered and thermally regulated bath of oil, it is relatively easy to design the ratchet assemblies with the high performance that the RICE system requires.

### High Speed Ratchet Assembly (RA):

Besides the high performance, the RICE & RICG environment requires ratchet assemblies that can respond to the high speed operation of these two systems.

Three factors are essential in the design of a high speed ratchet assembly:
1. The pawls have to have small mass so they may respond to the required quick movements.
2. The spring loading of the pawls have to be strong to quickly move the pawls on the teeth.
3. The distance that the pawls have to travel has to be small (short ratchet teeth).

The pawls have to share the load: the forces and the stresses that each pawl has to stand are equal to the load divided by the number of engaged pawls. Therefore a high performance, high speed RA is equipped with many low mass pawls that are spring loaded with a high spring constant, and short ratchet teeth.

The teeth inside the proposed ratchet ring of FIG. 15a are so fine (1-3 mm deep) that they are not visible in the figure. The close-ups in FIG. 15b & FIG. 15c indicate that these teeth have the conventional saw-like structure. The ratchet ring is about 1 cm thick with the ID=8 cm & OD=10 cm. FIG. 15d, FIG. 15e, & FIG. 15f propose a ring in which the pawls, the springs, and the pawl ring are integrated into a single piece. FIG. 15d, FIG. 15e, & FIG. 15f depict a proposed RA in which the pawls have to stand tension when they block the load. The inner gears of the pawl ring are to lock this ring to a desired shaft. The spoke like pawls on the pawl ring are such that each spoke would have the ability to slightly bend. The designed teeth at the end of each pawl are a replica of the ratchet teeth in the ratchet ring. The pawl ring is also about 1 cm thick. The ID & OD of the pawl ring are 5 cm & 8.3 cm respectively. Because the OD of the pawl ring is 0.3 cm larger than the ID of the ratchet ring, these two rings cannot be assembled without a gig. A special gig would force all the spokes of the pawl ring to collapse slightly so that it could be inserted inside the ratchet ring. This structure would operate in a pool of oil. Much like a saw that moves with ease in one direction, here too the pawl ring would almost freely rotate in the counterclockwise direction. But the two rings completely lock into each other in the clockwise direction. FIG. 15g, FIG. 15h, & FIG. 15i depict a ratchet assembly using the same technique, except the teeth on the pawls are designed such that the pawls would go under compression stress, instead of tension, when they block a load.

### Sealing and Lubrication:

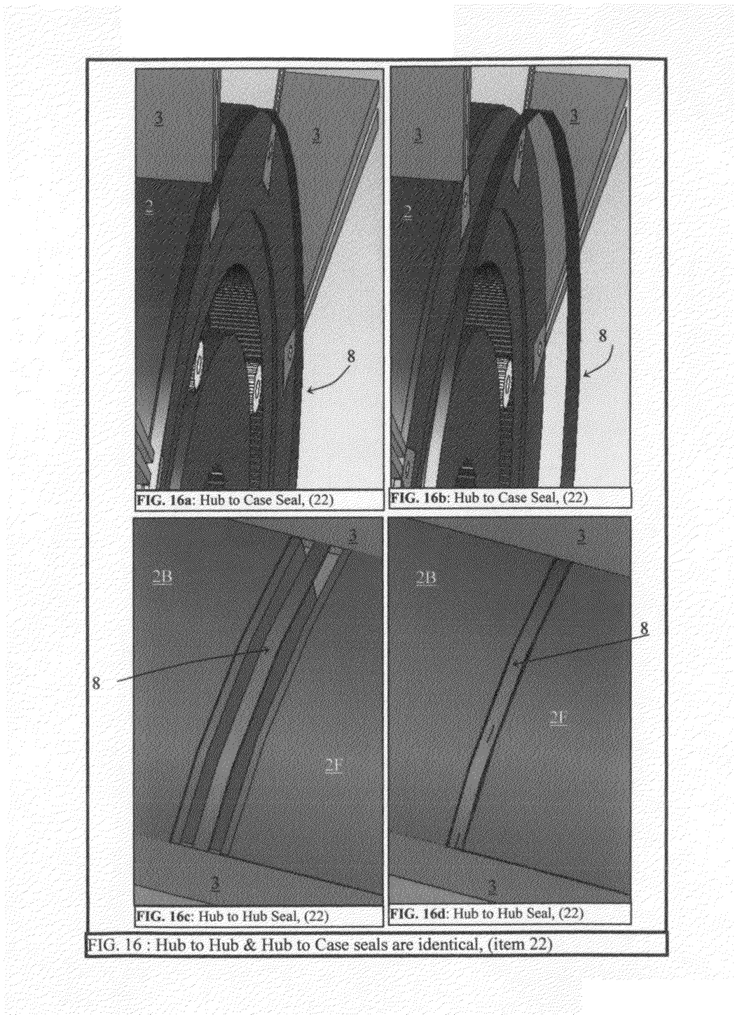

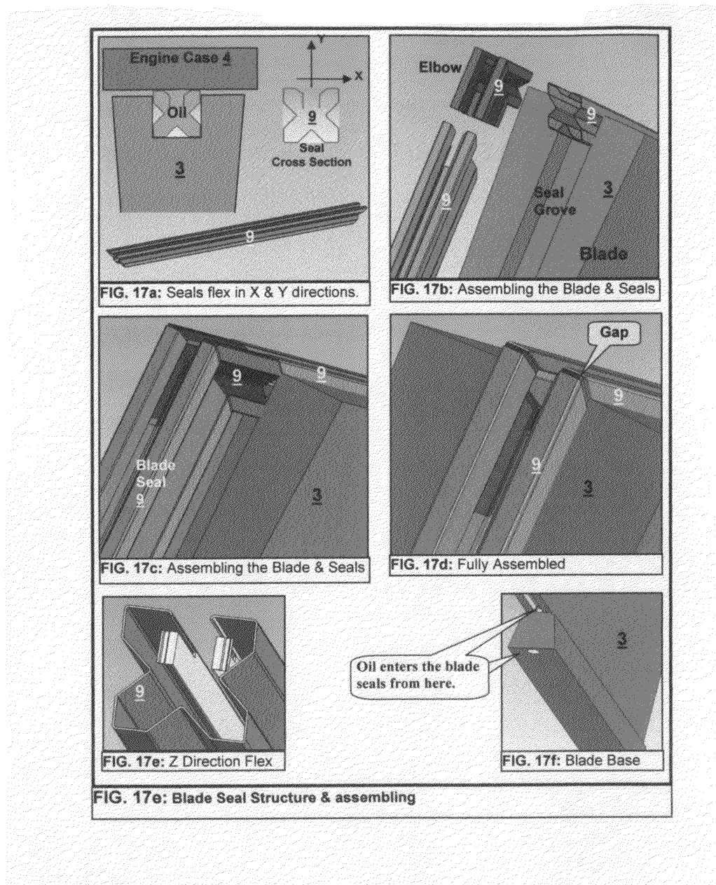

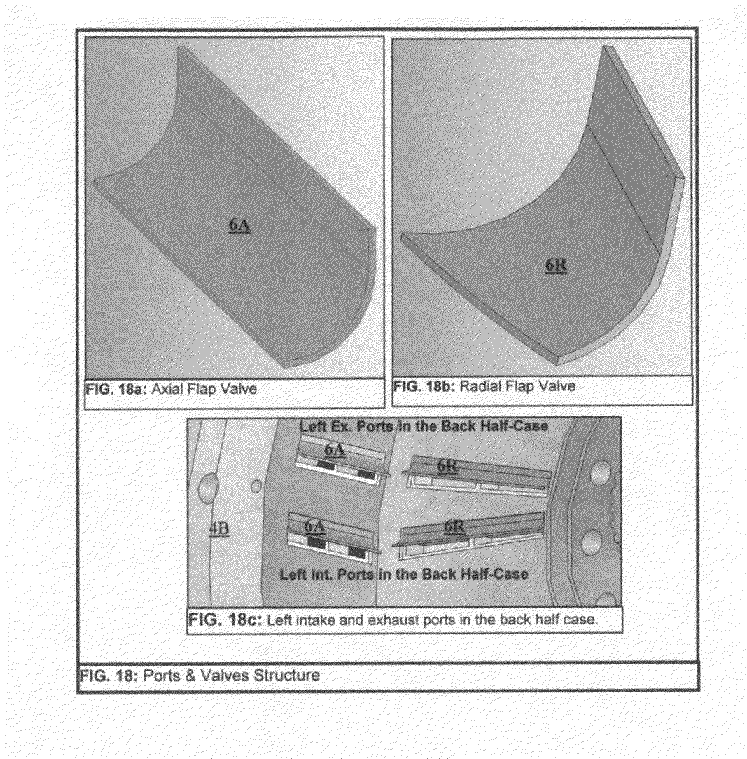

Hub Seals: Item 8 in FIG. 8a; FIG. 8b; & FIG. 16 is a thin hoop of steel (0.5 mm thick & about 12 mm wide). FIG. 16c & FIG. 16d indicate that one of these hoops (item 8) seals the two adjacent edges of the two hubs to each other. FIG. 16a & FIG. 16b indicate that two more of these hoops (item 8) seal the two other nonadjacent edges of the two hubs to the two grooves inside each of the two half-cases. In a P&C a pressure seal ring needs not to fit tightly in its groove around the piston. This is because the chamber gas pressure presses down on the pressure seal and tightens it against the lower walls of the seal groove on the piston. But, to stop the high pressure combustion gasses leak in between the pressure rings and the cylinder walls, the same pressure ring has to press on the cylinder walls with a higher pressure than the peak pressure of the combustion gasses. Here too the hub seal hoops need not to fit tightly around the hubs or inside the engine case grooves. This is because the gases in the compression and the power chambers press on these rings and force them to sit and seal tightly on the hubs and or on the engine groove walls.

Blade Seals: Much like the piston pressure rings, in a P&C, that have to press hard on the cylinder walls; here too the blade seals have to apply a higher pressure than the peak combustion pressure on the inside walls of the engine case. This is to stop the high pressure gasses from the compression and or power chambers leak out and loose performance & power. The proposed blade seal system introduced in FIG. 17 has a dual function: it lubricates and it seals. The cross section of the seals shown in FIG. 17a indicates that the seal is flexible in the shown X & Y directions. The spring constant in the Y direction has to be large, especially for engines that are designed for diesel cycle. The elbows that join the seals at the corners have the same cross sectional profile, but are made from a thinner material. This is to make the spring constant of the elbows to be much smaller than the main seal in both directions. This is to allow the main seal control the sealing forces it applies to the chamber walls and or to the blades' groove walls. To avoid leakage, the seals have to also press around the holes where oil enters and leaves the seals (Z direction). This is accomplished in FIG. 17e, where a spring is formed in the Z direction to force the elbows out; thereby sealing around the holes where oil enters and leaves the blade seals. In a P&C, the force that the connecting rod applies to the piston has both vertical and horizontal components. As the result the piston is subject to cogging. Consequently the piston diameter has to be made a bit smaller than the cylinder diameter. As the result a pressure ring has to stand and convey the large forces that the compression and combustion gasses produce on them. But in RICE there is no cogging problem. Therefore the rotor diameter is almost exactly equal to the inside diameter of the cavity that the two halves of the engine case make. As the result the compression and combustion forces that the blade seals have to stand and convey are ignorable. The superior operational and structural symmetry of RICE allows a tighter and more efficient sealing system than the sealing of a P&C. FIG. 17f shows the hole at the base of a blade where oil enters the blade seals from the core of the engine through the hubs.

Blade Seal Fabrication: A thin and narrow ribbon of steel shall be pulled through a die to form a gutter-like profile similar to the one shown at the top right corner of FIG. 17a. The spring constant of the profile in the X & Y directions shall be controlled by the ribbon thickness, the magnitude of the pertinent angles that allow flexibility in the X & Y directions, and the ribbon material. The widths of the blade seal-grooves are slightly smaller than the width of the produced seal profile. The produced profile is flexible in X and Y directions; so that to control the tightness the seals would fit inside the grooves and also the pressure the seals apply to the walls of the engine case. FIG. 17b, FIG. 17c, & FIG. 17d show the four segments of the blade seal integration. Once the blades of each rotor are equipped with these seals, special gigs shall be used to press them down so that each rotor could be inserted inside the engine case and coupled to the other rotor.

Oil Flow inside the Blade Seals: In FIG. 8b, the thick orange dashed line around the blade and out, indicates that the oil flows inside the blade seals. As each rotor turns the imbalance centrifugal force on the oil causes it to flow. The purpose of the double hub-to-case seals in FIG. 8b is to create an imbalance in the centripetal force on the oil so that it would flow. The oil flows into the seals from the core of the engine, (where the shaft, the RAs, & OBs are) through the radial small holes in the hubs. The oil will then flow out of the seals and out of the engine case, and once it has been cooled and filtered it will return to the engine core again. If the centripetal force mechanism did not provide a desired flow rate, then the oil has to be pressurized to make a desire flow rate in the oil cooling system possible.

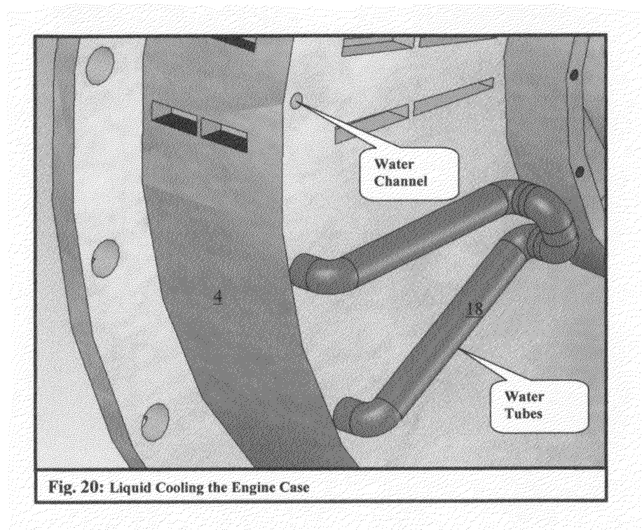

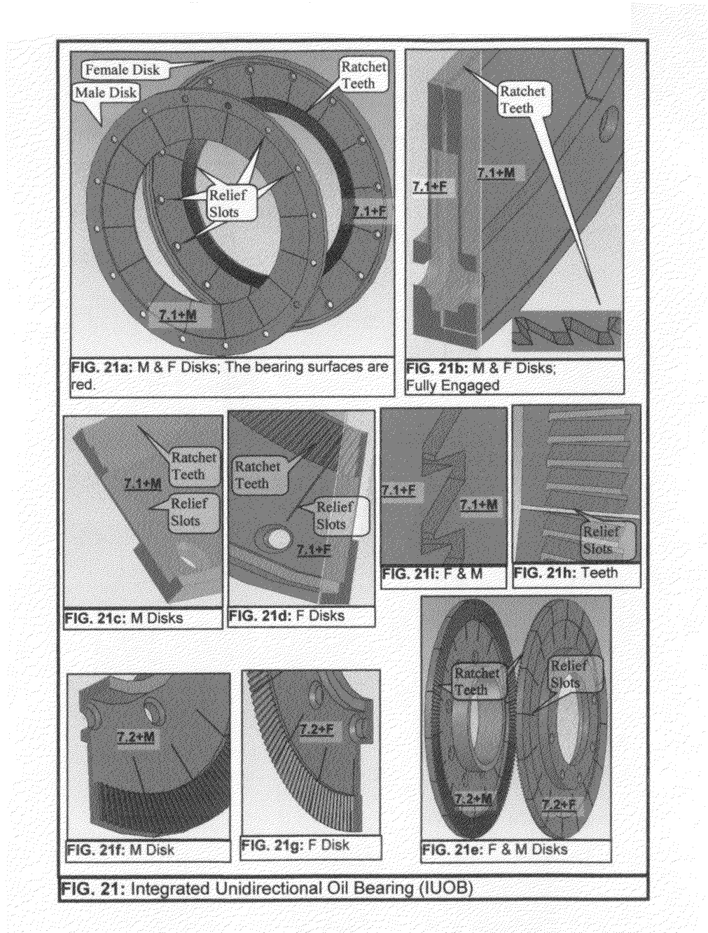

Lubrication & Flap Valves: As the blades pass over the ports, the oil that flows inside the blade seals wants to leak out of the engine ports, and worse yet the oil wants to leak into the chambers. FIG. 18 depicts radial and axial flap valves that were mounted on each port in such a direction that allows the blades to spread the flaps and momentarily close the ports as the blades pass over them. As shown in FIG. 18 & FIG. 19 there are radial and axial ports for both the intake and exhaust ports in each half of the engine case. And as shown in FIG. 18a & FIG. 18b there are radial (item 6R) and axial (item 6A) flaps for these ports. FIG. 19a indicates that the directions of the bonding of the flaps have to be compatible with the direction of the rotation of the blades.

Flap Valves: Several operational notes indicate that the flap technique will work. First: FIG. 18 & FIG. 19 indicate that these flaps are very short in the direction that they have to flap. Therefore these flaps can respond to the high frequency operation of the engine. Second: FIG. 19d and FIG. 19e show that at the time a blade reaches a flap its speed is almost zero: The back blade in FIG. 19d has been stationary, in between the intake and exhaust ports, and now wants to gain speed to slowly pass over the intake flaps. The front blade in FIG. 19d & FIG. 19e is slowly approaching the exhaust flaps and will come to complete stop as soon as it passes over the exhaust flaps. Therefore the interactions of the blades and the flaps are slow and soft. Third: P&C engine valves are exposed to the highest temperatures and the pressures that combustion gasses produce. But in RICE by the time the gasses reach the flaps they have expanded and have dramatically dropped their temperatures and pressures. Fourth: the main cooling mechanism of the P&C engine valves is conduction through the valve seats. But in RICE beside its seats, a flap gets cooled by the oil every time a blade slowly passes over it. Fifth: a prototype of the flap technique has been made and tested with air compressor. It has been found that the spring constant of these flaps need not to be high and the flaps need not to be as erect as is shown in FIG. 18 & FIG. 19 to stay open and allow the exhaust stroke. The structures of flaps at the intake ports are identical to the ones at the exhaust ports—they all are curved to stand semi-erect inside the chambers.

Heat Management: For every power stroke period that heats up a blade, there are three other stroke periods that allow a blade to cool. The blades are almost thermally equivalent to the chamber walls of a P&C. But heat wise the RICE engine case is in much more trouble than a P&C system. The power portions of the RICE engine case are repeatedly exposed to the high temperatures of combustion in every stroke. As was pointed early on, the P&C system distributes its four strokes over time, but RICE distributes its four strokes over space. In this context P&C is a time machine, but RICE is a space machine. This fundamental difference freed RICE from the strict active valve timing that a P&C system requires. That freedom yielded to the transformation of RICE into an electro combusting state machine. But now the same fundamental is working against RICE and repeatedly concentrating heat into a relatively small space of the case. Therefore RICE requires extensive heat management. Liquid cooling shall be employed to combat this challenge during development. FIG. 20 proposes a simple plumbing of the liquid into and around the case for prototyping. For mass production the plumbing would be designed imbedded inside the case.

Integrated Unidirectional Oil Bearing (IUOB): FIG. 21a proposes an IUOB with reference number 7.1 in which an axial oil bearing, a radial oil bearing and an oil ratchet assembly are integrated into two disks. As shown in FIG. 21c & FIG. 21d each disk is equipped with radial ratchet teeth that are fabricated at the inner portion of each disk. The red surfaces at the outer portion of each disk function as the sliding surfaces of a radial and an axial oil bearing. FIG. 21b shows that when RICE is assembled the male disk fits into the female disk, the red bearing surfaces come to a niece contact, and all the teeth from the male disk fit inside all the teeth from the female disk. The portion of each disk between the bearing surfaces and the ratchet teeth is thin to provide flexibility. The radial relief slots in each disk allow the sections between the slots to be able to slightly bend in the axial direction. This slight bending capability together with the directional fabrication of the teeth, shown in FIG. 21f & FIG. 21g, allow each disk to be able to only rotate in one direction with respect to the other (assume male counterclockwise). The two disks then completely lock into each other if any of them tries to rotate in the opposite direction with respect to each other (male clockwise). The ratchet teeth are identical in both disks. Here all the teeth share the stress that the load applies. Therefore each tooth could be remarkably small. Moreover since both sides are ratcheting, the amount of required bending from each slice is half as much. The two disks shall be screwed (16 holes are provided in each disks of FIG. 21a) to the two components that a designer wants to maintain a unidirectional relationship. FIG. 21f, FIG. 21g, & FIG. 21e propose another IUOB with reference number 7.2 in which the positions of the oil bearings and the ratchet teeth have been switched.

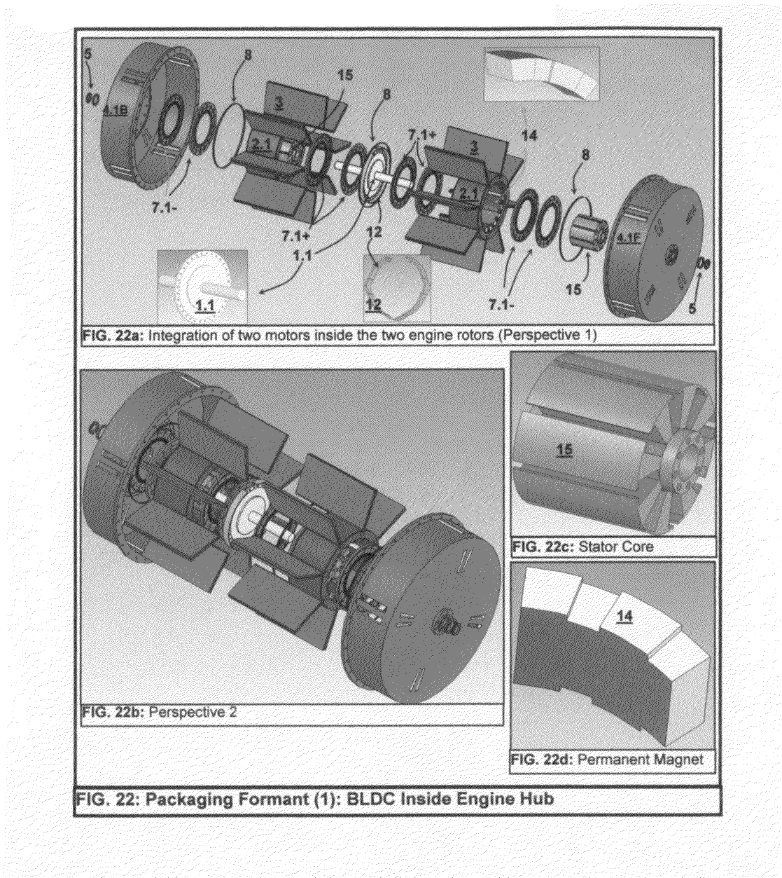

Other Packaging Formats (1): The structure of RICE in FIG. 22a is almost identical with the structure of RICE in FIG. 8a. Each oil bearing and ratchet assembly, at each side of the two hubs in FIG. 8a is replaced with an IUOB shown in FIG. 21. The four motors at each side of RICE in FIG. 8a are replaced with a single motor structure housed inside each hub of FIG. 22a. The four motors with reference number 10 in FIG. 8a have to be able to produce the required torque for compression. Choosing the appropriate diameter for the gear 11 allows a RICE designer to make this requirement come true. FIG. 22 proposes a RICE packaging format in which one motor housed in each hub replace a set of the four motors. The permanent magnets (item 14 shown as blue & red in FIG. 22a) are bonded to the inside of each hub. Item 15 shown in FIG. 22a & FIG. 22c is the core for the stator coils of the proposed motors. Several screws fasten (8 fastening holes are shown on the right side of FIG. 22c) a core to the inside center of each half-case. The hole in the middle of the core allows the engine shaft (reference 1.1) to pass trough it. The stator coils are not shown in the figures. It is understood, however, that the stator coils are simple windings that would fit around the spokes of the stator core (item 15). Each of the motors housed inside each of the two engine rotors has to be able to produce the same torque that the four motors in FIG. 8a were able to collectively produce. Worse yet here there is no gear ratio advantage like what gear 11 used to provide. This puts a limit on engine to motor ratio: the diameter of the engine divided by the diameter of its hubs. The bigger the hub the bigger the proposed motors would be; and the smaller the case the smaller the blades and the smaller the required compression torque would be. There would be an upper limit on engine to motor ratio beyond which the motors would overheat if they try to deliver the torque that compression requires. What comes to the rescue is the fact that brushless DC motors are good torque producers and their peak torque capability is when their rotors are standing still. The engine compression peak torque demand is also when the rotor is standing still. The permanent magnets, the cores, and the stators are all dipped and sealed in epoxy before submerging them in the same bath of oil that submerges the shaft, the OBs, & IUOBs. As was mentioned before the oil is actively being cooled. Therefore the motors could require a cooling temperature from the oil flow system that would allow them to produce the required torque without overheating. The coils will be electrically connected to produce a standard three phase stator structure as shown in FIG. 8c. Two independent motor drivers similar to FIG. 8c control the directions and or the magnitudes of the electromagnetic forces on the two engine/motor rotors.

Power Density: The diameter of this design is about 1m, and its length is about 0.5 m. The hub diameter is 0.5m. The power capability equation that this patent uses is: Pᵥ=(number of power chambers in each stroke) multiplied by (the displaced volume of a chamber). Therefore Pᵥ=(4)[3.14(500²-250²)×(500)(35/360)]=114479166.7 mm³=115 liter. The block volume of this engine is: 3.14×500²×500=392500000 mm³=392.5 liter. The power density is therefore=29%, which is almost twice as much as the previous packaging format. This RICE design is suboptimum because its hubs are too large, and the aspect ratio of the blades is random. With a smaller hub design and an optimum blade aspect ratio the power capability and power density will improve.

Using the same power capability equation reveals that a large SUV with 8 cylinder engine has about 6 liter power capability yet its size is about the same as this RICE design. Assuming 6 liter power capability is the same as 300 HP, the current RICE design would have 5750 HP power capability.

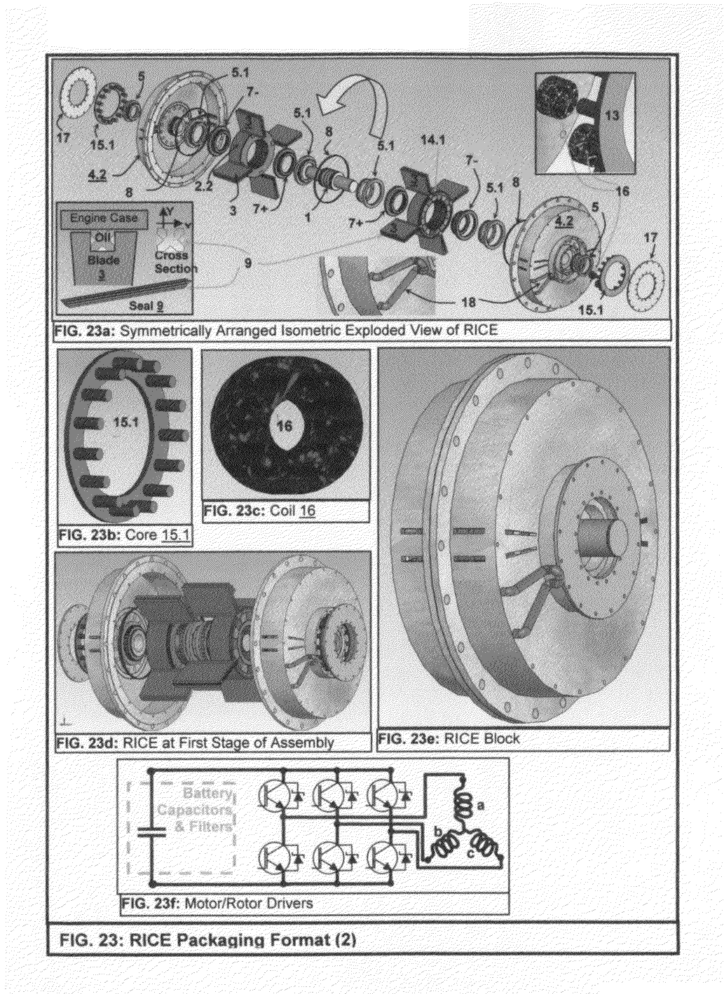

Other Packaging Formats (2): FIG. 23a proposes a packaging format in which the permanent magnets are bonded to the faces of the two hubs. Here the stators and the core could be housed in a special cavity where there is no oil. Item 15.1 in FIG. 23a is the core of the motors. The fingers of the core penetrate through the case and form a small gap with permanent magnets. Item 16 in FIG. 23c is the stator coil that would fit around the fingers of the core. FIG. 23d depicts the engine at a more advanced stage of assembly. FIG. 23e depicts the engine block at its near final stage of assembly.

RICG: Rotary Internal Combustion Generator: A generator has to be added to a P&C engine to create a conventional electric power generating system. But here the hardware needed for electric power generation already exists in RICE. When the main intention is to create electricity then the mechanical power generating hardware of RICE is no longer needed. Therefore the engine shaft (item1.1 in FIG. 22a), the two IUOBs that couple the rotors to the shaft (two item 7.1 in FIG. 22a), and the two OBs that were supporting the two ends of the shaft (two item 5 in FIG. 22a) could be discarded. Because parts were eliminated from RICE, the power density of RICG would be even higher than the calculated 29% for RICE.

The same detection and programming scheme that runs RICE would also run RICO. Active rectification (FIG. 23c) allows electric power draw from any coil that is not used during combustion.

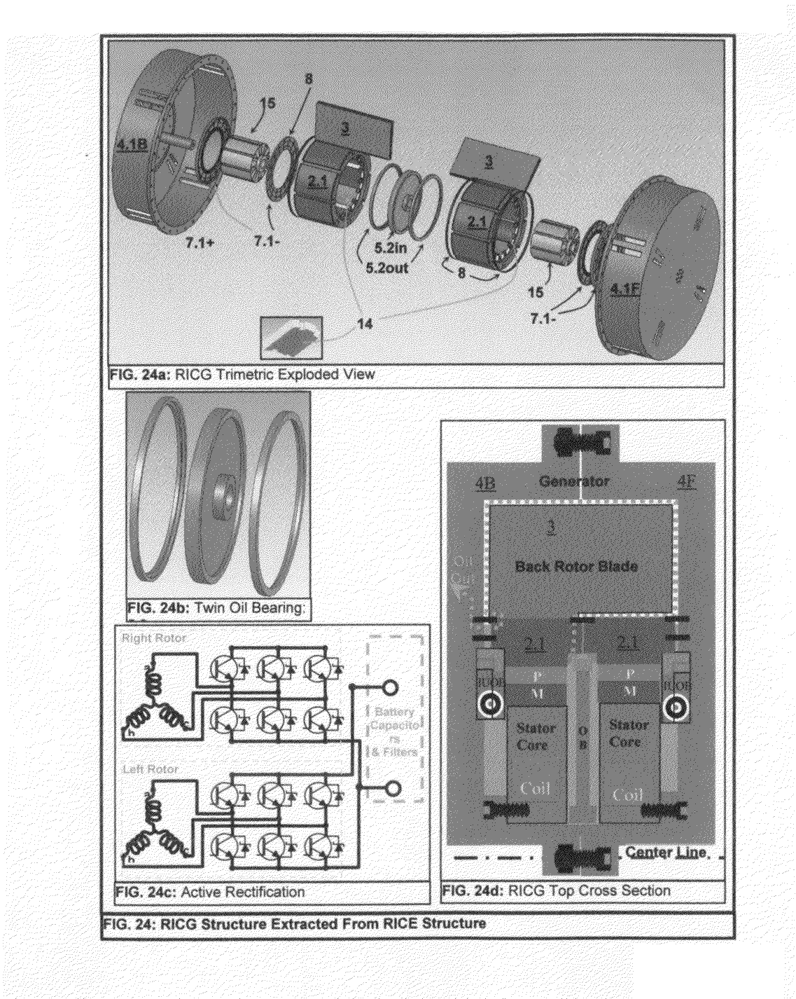

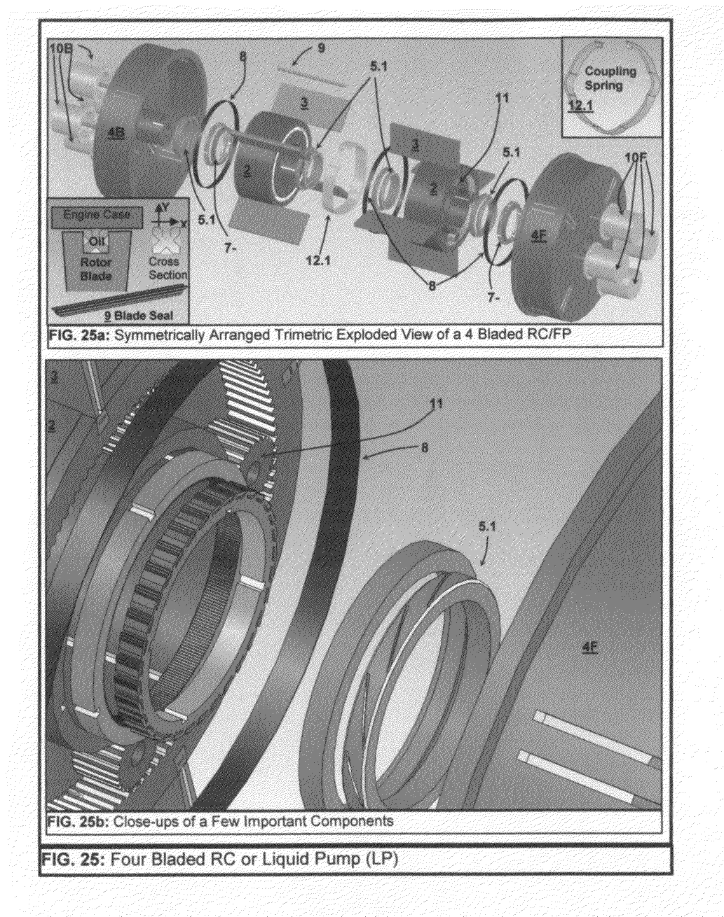

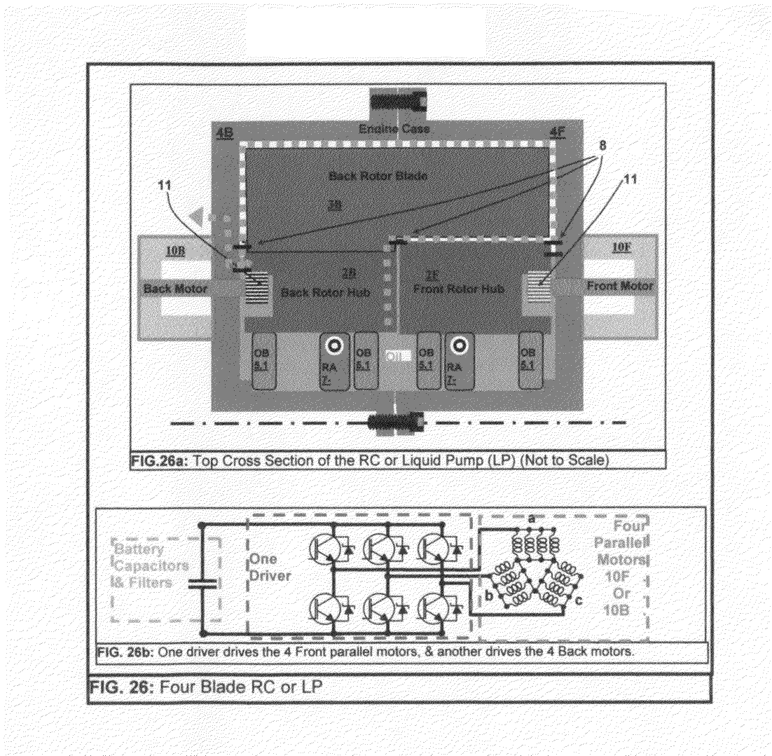

FIG. 24a depicts a trimetric perspective view of an eight bladed Rotary Internal Combustion Generator (RICO). FIG. 24a & FIG. 24d indicate that a single nut & bolt join the center post of the two half-cases together. The two half-cases are also joined together at their outer perimeters by several others nuts & bolts. One stator core (item 15) is fastened to the center of each half-case by several bolts. The stator coils are not shown in the figures. It is understood, however, that the stator coils are simple windings that would fit around the spokes of the stator core (item 15). The nonadjacent sides of each hub are coupled to the appropriate half-case through an IUOB. This would constrain each rotor to only rotate in the counterclockwise direction. The adjacent sides of the hubs are riding on a twin oil bearing (5.2in & 5.2out, FIG. 24a & FIG. 24b). The “5.2in” ring is stationary and the two “5.2out” rings are rotating with their respective hubs.

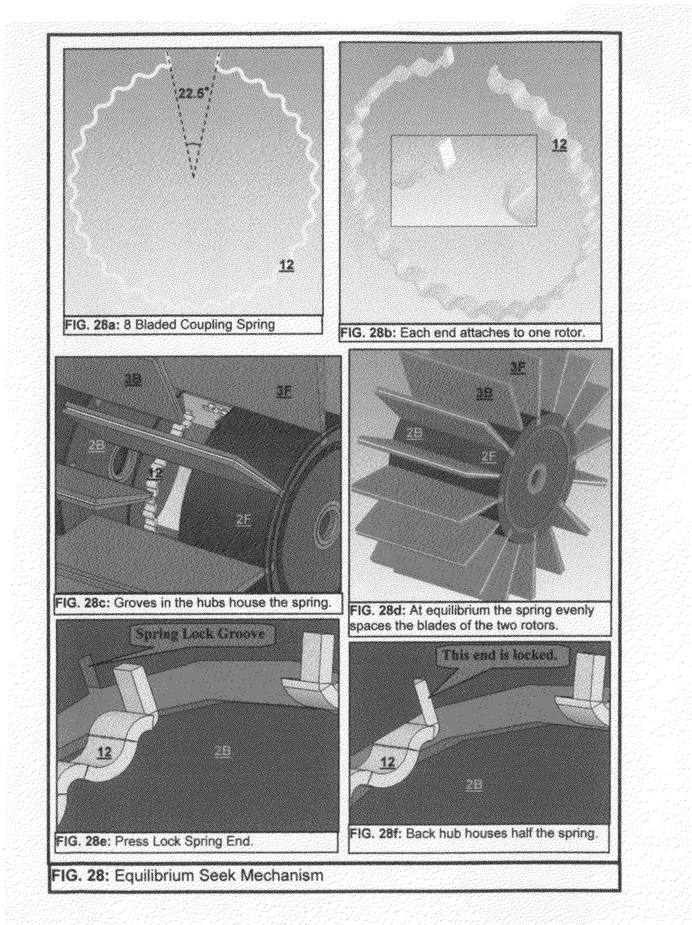

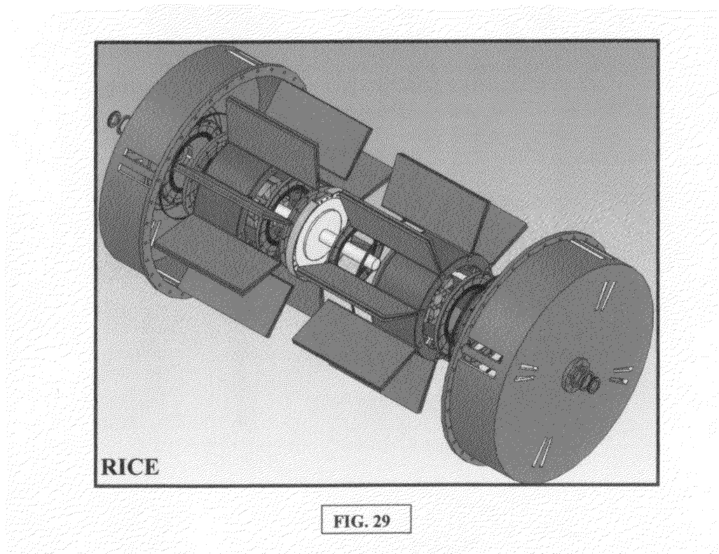

Rotary Compressor (RC)/Liquid Pump (LP): A rotary compressor is extracted from RICO by eliminating its combusting system. Because of the gear ratio advantage (gear 11), the configuration with the motors outside the case is better suited for high pressure RC. But for low pressure RC the motors could still be housed inside the hubs. Because combustion was eliminated detector D1 is no longer needed, and also the operating program would become simpler. FIG. 25a & FIG. 25b depict the exploded view of a 4 bladed RC with its Front & Back motors outside the case. The interface between the motors and the hubs is a little bit different than the one introduced in FIG. 8. The corrugations in the coupling spring need not to be as elaborate as was previously introduced in FIG. 28. Only three corrugations were designed in the coupling spring 12.1 shown at the top right corner of FIG. 25a. As is shown in FIG. 25 & FIG. 27a the case of RC/LP has twice as many ports as a 4-bladed RICE does. FIG. 26a depicts the top cross section with oil flowing around the blades. For pumping a lot of viscous fluids the oil flow around the blades could be eliminated. FIG. 26b depicts that a single driver drives the four Front motors. Another similar driver drives the four Back motors.

RC/LP Program & Operation: FIG. 27h, FIG. 27c, FIG. 27d, FIG. 27e, & FIG. 27f depict the snapshots of the sequential events that should cause the servo change the state of the system from one to the next. The snapshot u in FIG. 27b depicts the system in a completely unknown condition. With the equilibrium seek mechanism of FIG. 28 the distance between the blades would be larger than the distance between the detectors. An external user wishes to turn on the RC. This wish is communicated to the servo by changing the external signal ES from ES=0 to ES=1. This will satisfy the else phrase in line 4 of the program in FIG. 27g. Therefore the servo will move on to line 5 which randomly directs the servo to change the state of the system from SB to FCC. FCC causes the Front rotor to start turning CounterClockwise which will also cause the Back rotor to turn counterclockwise too. Eventually D2 will detect the back rotor (snapshot 1 in FIG. 27c). Detecting the back rotor is equivalent to (D2D3=10xx), which is the satisfying condition for the else-if phrase in line 8 of the program in FIG. 27g. The servo is now allowed to move on to line 9 and set the state to FCCBC. BC will lock the Back rotor under D2; while FCC forces the Front rotor continue turning CounterClockwise. Eventually D3 will detect the Front rotor, and the event (D2D3=1001) will take place (snapshot 2 in FIG. 27d). This event is the satisfying condition for the else-if phrase in line 14 of the program. Therefore the servo is allowed to move to line 15 in which the program directs it to let go of the Back rotor and continue turning the Front rotor CounterClockwise. The set state will eventually cause the Front rotor reaching D2 (snapshot 3 in FIG. 27e). This event is equivalent to (D2D3=01xx) which is the satisfying condition for the else-if phrase of line 20. Line 21 directs the servo to set the state to BCCFC. This locks the front rotor under D2 and continues turning the back rotor CounterClockwise. The back rotor will eventually reach D3 and bring about the event (D2D3=0110), (snapshot 4 in FIG. 27f) which is the satisfying condition for the else-if phrase in line 26 of the program. The servo moves on to line 27 and then line 28, which directs the servo to go to line 6. During the ON time the servo loops around from line 6 to line 28 and back to line 6. During the OFF time the servo loops around from line 1 to line 3 and back to line 1. At any time the RC/LP user can switch the operation of the servo between the ON loop and the OFF loop by changing the value of the external signal ES.

### BRIEF DESCRIPTION OF THE SEVERAL VIEWS OF THE DRAWINGS & REFERENCE NUMBERS

Copies of this patent with color drawings will be provided by the Office upon request and payment of necessary fee.

### 1: Engine Shaft

1.1: Engine Shaft with IUOB

### 2: Rotor Hub

2.1: Rotor Hub with Integrated Motor

### 3: Rotor Blade

### 4: Engine Case

### 4F: Front Half-Case

### 4B: Back Half-Case

4.1: Engine Case with Integrated Motor
4.1F: Front Half-Case with Integrated Motor
4.1B: Back Half-Case with Integrated Motor

### 5: Shaft to Case Oil Bearing

### 5.1: Hub to Case Oil Bearing; Hub to Shaft Oil Bearing

### 5.2in: In Ring of Twin Oil Bearings (Hubs to Case)

### 5.2out: Out Ring of Twin Oil Bearing (Hub to Case)

### 6: Flap Valves

### 6A: Axial Flap Valve

### 6R: Radial Flap Valve

7−: Hub to Case Ratchet Assembly (RA), (negative direction)
7+: Hub to Shaft Ratchet Assembly (RA), (positive direction)

### 7.1−: Hub to Case Integrated Unidirectional Bearing (IUOB)

### 7.1+: Hub to Shaft Integrated Unidirectional Bearing (NOB)

### 8: Hub to Hub Seal; Hub to Case Seal

### 9: Blade Seal

### 10: Motor

### 11: Motor to Hub Gear

### 12: Coupling Spring

12.1 Coupling Spring with 3 Corrugations

### 14: Axial Permanent Magnet

### 14.1: Radial Permanent Magnet

### 15: Stator Core

### 16: Stator Coil

### 17. Motor Cavity Cover

### 18. Water Cooling Pipe

FIG. 1 depicts a conventional Piston & Cylinder engine.

FIG. 2 depicts a rotary suggestion without the hardware that keeps the appropriate spatial relations between the rotors to bring about the necessary sequential strokes .

FIG. 3 depicts a dimensional estimate of a V8 engine. FIG. 3c depicts engine block power density calculation.

FIG. 4 depicts a dimensional representation of a 4 bladed RICE. FIG. 4c depicts engine block power density calculation.

FIG. 5 depicts the structure of a Blade, a Hub, an 8 bladed Rotor, and an 8 bladed Coupler.

FIG. 6a depicts a 2 bladed RICE with some of its basic features. FIG. 6b depicts a 4 bladed RICE with some of its basic features. FIG. 6c depicts a 6 bladed RICE with some of its basic features.

FIG. 6d depicts an 8 bladed RICE with some of its basic features.

FIG. 7 depicts the structure of a 2 bladed, a 4 bladed, & an 8 bladed engine rotors and couplers.

FIG. 8a depicts the detailed exploded view of an 8 bladed RICE. FIG. 8b depicts the top cross section of the engine. FIG. 8c depicts the four small gears that come through the case to interface with the hubs of the two rotors. FIG. 8d depicts the electric circuit that drives 4 parallel motors.

FIG. 9 depicts the position detection scheme of the blades.

FIG. 10 depicts the detail representation of a 4 bladed RICE.

FIG. 11 depicts the sequential snapshots of a 4 bladed RICE at different stages of being turned on.

FIG. 12a depicts the engine operation program. FIG. 12b depicts program code list.

FIG. 13 depicts the 6 bit word digitization of the 6 detectors.

FIG. 14 depicts an oil bearing.

FIG. 15 depicts two possible ways to construct Ratchet Assemblies (RA).

FIG. 16 depicts how the hubs are sealed to each other and to the engine case.

FIG. 17 depicts the seal structure of the blades.

FIG. 18 depicts the flap valve structure of the ports.

FIG. 19 depicts how the flap valves interact with the blades.

FIG. 20 depicts how liquid cooling could be implemented.

FIG. 21 depicts an Integrated Unidirectional Oil Bearing (IUOB).

FIG. 22 depicts how the motors could be housed inside the engine hubs.

FIG. 23 depicts how the motors could be housed on the faces of the hubs.

FIG. 24 depicts how a RICG structure could be extracted from a RICE structure.

FIG. 25 depicts how a Rotary Compressor structure could be extracted from a RICE structure.

FIG. 26 depicts the top cross section of RC or LP, and the Front or Back Motor driver.

FIG. 27a depicts the snapshots of the events at which computer has to change RC states.

FIG. 27b depicts RC or LP operation program.

FIG. 28 depicts the coupling spring and the equilibrium seek mechanism.

I claim:

1. A rotary internal combustion engine comprising:
a. a front hub and a back hub, with equally spaced even numbers of blade fastening means made on each of said two hubs, and the same numbers of hub-oil-holes made in each of said two hubs, and when said engine is assembled the back face of said front hub faces the front face of said back hub, and a circular spring-groove made on the back face of said front hub, and a similar circular spring-groove made on the front face of said back hub, and three hub-seal grooves made on each of said two hubs, and a set of radial gear teeth made on the front face of front hub, and a similar set of radial gear teeth made on the back face of back hub, and
b. a plurality of external to case front motors that mechanically engage to said radial gear teeth of front hub, and a plurality of external to case back motors that mechanically engage to the radial gear teeth of said back hub, and
c. a coupling spring, half of which is housed inside said spring-groove of the front hub, and the other half of said spring is housed inside said spring-groove of the back hub, and one end of said sprig locks to the inside of said spring-groove of the front hub, and the other end of said spring locks to the inside of said spring-groove of the back hub thereby coupling said two hubs together and creating a coupler, and said spring is such that when left at equilibrium the blades of one rotor are at equal distance from the blades of the other rotor, and the design of the spring and the spring-grooves are such that the spring enters into different force modes when the blades of one rotor wants to collide with the blades of the other rotor, and
d. five thin hub seal rings, the first said ring seals the out back edge of said front hub to the out front edge of said back hub, the second of said rings seals the out front edge of the, front hub to the engine case, and the third of said rings seals the out back edge of the back hub to the engine case, the forth of said rings seals the mid front seal-groove of said front hub to the engine case again to create a differential centripetal force on oil which makes said oil flow inside the front blades seal systems, the fifth of said rings seals the mid back seal-groove of said back hub to the engine case again to create a differential centripetal force on oil which makes said oil flow inside the back blades seal systems, and
e. a plurality of blades, the bases of which fasten onto said two hubs to create a front rotor and a back rotor, and a sensing target bonded to the base of each of said blades to allow appropriate detectors sense the positions of said front or said back blades, and a blade-oil-hole made at the base of each of said blades that would lineup with said hub-oil-hole to allow oil to flow from the core of the engine to each of the blade-seal system, and blade-seal-grooves made on each sliding sides of each of said blades, and
f. a plurality of sets of blade seals, flexible in x, y, & z directions, that would fit inside said blade-seal-grooves to seal of the space between the blades of said front rotor and the blades of said back rotor, and
g. a front half-case, and a back half-case, with appropriate plurality of intake and exhaust ports with appropriate shapes and appropriate positions in each of said half-cases, and the cavity formed from joining said front half-case to said back half-case would appropriately house the internal components, and
h. a plurality of flap valves designed for every said port, and blades momentarily close said valves to stop the oil in said blade seal systems from leaking out of said ports, and
i. a plurality of detectors, positioned at appropriate locations, to report the detection of said front or of said back blades, and
j. two counterclockwise ratchet assemblies one of which couples said front hub to said front half-case, and the other said counterclockwise ratchet assembly couples said back hub to said back half-case, and
k. a central engine shaft that passes through said coupler and said two half-cases, and
l. two clockwise ratchet assemblies one of which couples said engine shaft to said front hub, and the other said clockwise ratchet assembly couples said engine shaft to said back hub, and
m. six bearings, the first bearing secures the front end of said engine shaft to said front half-case, the second bearing secures the back end of said engine shaft to said back half-case, the third bearing secures the front end of said front hub to said front half-case, the forth bearing secures the back end of said front hub onto said engine shaft, the fifth bearing secures the front end of said back hub onto said engine shaft, the sixth bearing secures the back end of said back hub to said back half-case, and
n. an electronic system capable of causing combustion in any of the combustion chambers, and said electronic system capable of driving any of said motors, and
o. a computer capable of commanding said motors and said electronic combustion system, and said computer is capable of executing any properly designed operating program, and
p. a program that when said computer executes, said engine operates as a designer has required.

2. A rotary internal combustion generator comprising:
a. a front hub and a back hub, with equally spaced even numbers of blade fastening means made on each of said two hubs, and the same numbers of hub-oil-holes made in each of said two hubs, and when said generator is assembled the back face of said front hub faces the front face of said back hub, and a circular spring-groove made on the back face of said front hub, and a similar circular spring-groove made on the front face of said back hub, and three hub-seal grooves made on each of said two hubs, and a set of radial gear teeth made on the front face of front hub, and a similar set of radial gear teeth made on the back face of back hub, and
b. a plurality of external to case front motors that mechanically engage to said radial gear teeth of said front hub, and a plurality of external to case back motors that mechanically engage to the radial gear teeth of said back hub, and
c. a coupling spring, half of which is housed inside said spring-groove of the front hub, and the other half of said spring is housed inside said spring-groove of the back hub, and one end of said sprig locks to the inside of said spring-groove of the front hub, and the other end of said spring locks to the inside of said spring-groove of the back hub thereby coupling said two hubs together and creating a coupler, and said spring is such that when left at equilibrium the blades of one rotor are at equal distance from the blades of the other rotor, and the design of the spring and the spring-grooves are such that the spring enters into different force modes when the blades of one rotor wants to collide with the blades of the other rotor, and
d. five thin hub seal rings, the first said ring seals the out back edge of said front hub to the out front edge of said back hub, the second of said rings seals the out front edge of the front hub to the generator case, and the third of said rings seals the out back edge of the back hub to the generator case, and the forth of said rings seals the mid front seal-groove of said front hub to the generator case again to create a differential centripetal force on oil which makes said oil flow inside the front blades seal systems, the fifth of said rings seals the mid back seal-groove of said back hub to the generator case again to create a differential centripetal force on oil which makes said oil flow inside the back blades seal systems, and
e. a plurality of blades, the bases of which fasten onto said two hubs to create a front rotor and a back rotor, and a sensing target bonded to the base of each of said blades to allow appropriate detectors sense the positions of said front or said back blades, and a blade-oil-hole made at the base of each of said blades that would lineup with said hub-oil-hole to allow oil to flow from the core of the generator to each of the blade-seal system, and blade-seal-grooves made on each sliding sides of each of said blades, and
f. a plurality of sets of blade seals, flexible in x, y, & z directions, that would fit inside said blade-seal-grooves to seal of the space between the blades of said front rotor and the blades of said back rotor, and
g. a front half-case, and a back half-case, with appropriate plurality of intake and exhaust ports with appropriate shapes and appropriate positions in each of said half-cases, and the cavity formed from joining of said front half-case to said back half-case would appropriately house the internal components, and
h. a plurality of flap valves designed for every said port, and blades momentarily close said valves to stop the oil in said blade seal systems from leaking out of said ports, and
i. a plurality of detectors, positioned at appropriate locations, to report the detection of said front or of said back blades, and
j. two counterclockwise ratchet assemblies one of which couples said front hub to said front half-case, and the other said counterclockwise ratchet assembly couples said back hub to said back half-case, and
k. no moving central shaft is required for said generator, instead a half-post extrudes from the center of each said half-cases, and when said two half-posts join together they support appropriate components, and
l. no clockwise ratchet assembly is required for said rotary internal combustion generator, and
m. four bearings, the first bearing secures the front end of said front hub to said front half-case, the second bearing secures the back end of said front hub onto said front half-post, the third bearing secures the front end of said back hub onto said back half-post, the forth bearing secures the back end of said back hub to said back half-case, and
n. an electronic system capable of causing combustion in any of the combustion chambers, and said electronic system capable of driving any of said motors, and
o. a computer capable of commanding said motors and said electronic combustion system, and said computer is capable of executing any properly designed operating program, and
p. a program that when said computer executes, said generator operates as a designer has required, and
q. electric power could be drawn from the motors' coils at periods of time that said coils are not participating in driving said motors, and additional coils could be added to each said motors for the sole purpose of drawing electric power.

3. A rotary compressor or liquid pump comprising:
a. a front hub and a back hub, with equally spaced even numbers or odd numbers of blade fastening means made on each of said two hubs, and the same numbers of hub-oil-hole made in each of said two hubs, and when said unit is assembled the back face of said front hub faces the front face of said back hub, and a circular spring-groove made on the back face of said front hub, and a similar circular spring-groove made on the front face of said back hub, and three hub-seal grooves made on each of said two hubs, and a set of radial gear teeth made on the front face of front hub, and a set of radial gear teeth made on the back face of back hub, and
b. a plurality of external to case front motors that mechanically engage to said radial gear teeth of said front hub, and a plurality of external to case back motors that mechanically engage to the radial gear teeth of said back hub, and
c. a coupling spring, half of which is housed inside said spring-groove of the front hub, and the other half of said spring is housed inside said spring-groove of the back hub, and one end of said sprig locks to the inside of said spring-groove of the front hub, and the other end of said spring locks to the inside of said spring-groove of the back hub thereby coupling said two hubs together and creating a coupler, and said spring is such that when left at equilibrium the blades of one rotor are at equal distance from the blades of the other rotor, and the design of the spring and the spring-grooves are such that the spring enters into different force modes when the blades of one rotor wants to collide with the blades of the other rotor, and
d. five thin hub seal rings, the first said ring seals the out back edge of said front hub to the out front edge of said back hub, the second of said rings seals the out front edge of the front hub to the compressor case, and the third of said rings seals the out back edge of the back hub to the compressor case, the forth of said rings seals the mid front seal-groove of said front hub to the compressor case again to create a differential centripetal force on oil which makes said oil flow inside the front blades seal systems, the fifth of said rings seals the mid back seal-groove of said back hub to the compressor case again to create a differential centripetal force on oil which makes said oil flow inside the back blades seal systems, and
e. a plurality of blades, the bases of which fasten onto said two hubs to create a front rotor and a back rotor, and a sensing target bonded to the base of each of said blades to allow appropriate detectors sense the positions of said front or said back blades, and a blade-oil-hole made at the base of each of said blades that would lineup with said hub-oil-hole to allow oil to flow from the core of the compressor to each of the blade-seal system, and blade-seal-grooves made on each sliding sides of each of said blades, and
f. a plurality of sets of blade seals, flexible in x, y, & z directions, that would fit inside said blade-seal-grooves to seal of the space between the blades of said front rotor and the blades of said back rotor, and
g. a front half-case, and a back half-case, with appropriate plurality of intake and exhaust ports with appropriate shapes and appropriate positions in each of said half-cases, and the cavity formed from joining said front half-case to said back half-case would appropriately house the internal components, and
h. a plurality of flap valves designed for every said port, and blades momentarily close said valves to stop the oil in said blade seal systems from leaking out of said ports, and
i. a plurality of detectors, positioned at appropriate locations, to report the detection of said front or of said back blades, and
j. two counterclockwise ratchet assemblies one of which couples said front hub to said front half-case, and the other said counterclockwise ratchet assembly couples said back hub to said back half-case, and
k. no moving central shaft is required for said rotary compressor, instead a half-post extrudes from the center of each said half-cases, and when said two half-posts join together they support appropriate components, and
l. no clockwise ratchet assembly is required for said rotary compressor, and
m. four bearings, the first bearing secures the front end of said front hub to said front half-case, the second bearing secures the back end of said front hub onto said front half-post, the third bearing secures the front end of said back hub onto said back half-post, the forth bearing secures the back end of said back hub to said back half-case, and
n. an electronic system capable of driving said motors, and
o. a computer capable of commanding said motors, and said computer is capable of executing any properly designed operating program, and
p. a program that when said computer executes said compressor operates as a designer has required.

4. The structures of claims 1, 2, & 3, where said radial gear teeth are replaced with axial gear teeth inside hub gear grooves as shown in FIG. 16a, and said motors interface with axial gear teeth instead.

5. The structures of claims 1, 2, & 3, where the blades fastening means is accomplished by making trapezoidal blade-grooves on said front hub and said back hub, and by making blade bases of trapezoidal profile that would fit and lock inside said trapezoidal blade-grooves on said hubs, shown in FIG. 5.

6. The structures of claims 1, 2, & 3 where the function of the front motors are integrated inside the front hub, and the function of the back motors are integrate inside the back hub, as shown in FIG. 22.

7. The structures of claims 1, 2, & 3, where the function of the front motors are integrated on to the front face of the front hub, and the function of the back motors are integrated on to the back face of the back hub, as shown in FIG. 23.

8. The structures of claims 1, 2, & 3 where the functions of ratchet assemblies are performed by the design of ratchet assemblies shown in FIG. 15.

9. The structures of claims 1, 2, & 3, where the function of ratchet assemblies and oil bearings are integrated into integrated unidirectional oil bearings, as shown in FIG. 21, FIG. 22, & FIG. 24.

10. The structures of claims 1, 2, & 3, where the function of blade seals is performed by the blade seal design in FIG. 17.

11. The structures of claims 1, 2, & 3, where the function of coupling spring is performed by the coupling spring design shown FIG. 28.

12. The structures of claims 1, 2, & 3, where the required blade detection scheme is achieved by the scheme shown in FIGS. 9, 11, & 13.

13. The structures of claims 1, 2, & 3, where the numbers of rotor blades are different than what are shown and proposed in this patent.

14. The structures of claims 1, 2, & 3, where the direction of the clockwise & counterclockwise ratchet assemblies are switched to allow the programming of the said embodiments for turning clockwise.

15. The structures of claims 1 & 2, where said structures operate with two strokes rather than the four strokes that is practiced in this patent.

16. The structures of claims 1 & 2, where the operating program is based on the scheme of FIGS. 11 & 12.

17. The compressor of claims 3, where the operating program is based on the scheme of FIG. 27.
